(19) United States
(12) Patent Application Publication
(10) Pub. No.: US 2007/0067267 A1
(43) Pub. Date: Mar. 22, 2007

(54) Systems and methods for managing the display of sponsored links together with search results in a search engine system

(76) Inventor: Stephen Ives, Swavesey (GB)

Correspondence Address: BARNES & THORNBURG LLP, P.O. BOX 2786, CHICAGO, IL, 60690-2786, US

(21) Appl. No.: 11/232,591

(22) Filed: Sep. 22, 2005

(30) Foreign Application Priority Data
Sep. 21, 2005 (GB) GB0519256.2

(51) Int. Cl. G06F 17/30

(52) U.S. Cl. 707/3

(57) ABSTRACT

We describe a method of managing sponsored links to be transmitted to mobile devices in response to search requests, the display of these links being responsive to time of day. The method comprises: maintaining records of advertiser accounts; monitoring an audience for the service; receiving from an advertiser a request for display of a sponsored link in association with a said search request keyword and an offer amount; forecasting a response rate for a sponsored link associated with the keyword; adapting said forecast response rate dependent upon a total demand; establishing a balance of total demand for responses to a said sponsored link associated with the keyword and predicted supply of said responses; and allocating said sponsored links for serving with search results such that sponsored links from a said advertiser offering a highest payment per response are served at least during one or more times having a highest audience.

### FIELD OF THE INVENTION

This invention is generally concerned with search systems for mobile devices and, more particularly, with improved techniques for managing the display of sponsored links together with search results in a search engine system. Embodiments are particularly useful for managing the display of search results on mobile devices in conjunction with sponsored links paid for by advertisers.

### BACKGROUND TO THE INVENTION

Embodiments of the invention we describe address three separate technical problems: primarily the relatively small display area available on most mobile devices, and as secondary problems, end-to-end latency effects within a mobile wireless communication network, and technical difficulties associated with displaying conventional hypertext markup language (HTML) webpages on mobile devices. We will describe each of these problems in more detail below.

In the field of television it is known to sell advertising for display in specific, fixed time periods. Likewise, in the Internet field, it is known to sell banner ads for display on web pages in specific time periods. Advertising with search results on desktop web pages is well established with the likes of Google's “AdWords”. The concept of auctioning of keywords within search engine services was originally invented by Goto.com (Goto.com, U.S. Pat. No. 6,269,361) who (as Overture Services, Inc) licensed their patents to Google. In such schemes, advertisers bid to have a link and associated line of text displayed whenever a particular keyword is used as a search term. These links are called sponsored links and link to sponsors' webpages.

In a mobile search service, there exists the same scope to enable advertising linked to search results. This type of advertising is very effective because it communicates with users at the very same time that they are searching for information or for a solution to get a job done. It is also very effective because if can be very precisely targeted. However, there are three main obstacles which inhibit this model from working as effectively with mobile handsets as it does with desktop PCs.

There is insufficient space on the screen of a mobile device to display a whole list of sponsored links on the screen at the same time as the search result list requested by the user. This reduces the revenue available to the search engine service. This first problem is the most significant and fundamental.

When clicking on a sponsored link, for example an advertising link, on a mobile device, there is a significant time delay before the user receives a web page over the air from the advertisers website, caused by end-to-end latency effects within the wireless network. The frustration induced by this delay reduces the frequency with which users will click on any given sponsored link.

The authoring and hosting of a mobile-specific web page is beyond the capabilities of many advertisers, many of which are small or medium businesses that do not have the time or inclination to create a mobile-specific version of their website.

There is therefore a need for improved techniques for presenting advertising (and other material), in particular in association with search results, on a wireless mobile communication device.

To address this need we will describe technology for automatically allocating advertisements by time-of-day into peak and non-peak time categories, based on observed user search traffic patterns. From the perspective of the mobile advertiser, we are providing a ‘bid-for-peak-time’ system. The described technology also incorporates, by technical means, the concept of paying for performance, that is of paying only for responses to advertisements.

### SUMMARY OF THE INVENTION

According to a first aspect of the present invention there is therefore provided a method of managing sponsored links to be transmitted to the screens of mobile devices in response to search requests from a searcher using a mobile device to access a search engine, online marketplace, or other similar service, the display of these links being responsive to time of day, the method comprising: maintaining records of advertiser accounts for payment for responses to a said sponsored link an advertiser account comprising at least an advertiser identifier and an account balance for each of a plurality of advertisers, sponsored links that correspond to search request keywords, modifiable offer amounts submitted by said advertisers each said offer amount being associated with at least one search keyword, and records of search requests using said at least one keyword and responses to sponsored links included with search results provided in response to said search requests; monitoring an audience for the service, said audience comprising the number of users carrying out searches within a given time interval at a said time of day; receiving from an advertiser a request for display of a sponsored link in association with at least one said search request keyword and an offer amount, said offer amount comprising an offer of payment for responses to said sponsored link, said offer of payment applying over a time period; forecasting a response rate for a sponsored link associated with said at least one keyword using said records of search requests using said at least one keyword and responses to sponsored links included with search results provided in response to said search requests; adapting said forecast response rate dependent upon a total demand for sponsored links associated with said at least one keyword as determined from said request received from said advertiser and one or more said requests from one or more other said advertisers; responding to said advertiser request using said adapted forecast response rate; determining an adapted forecast response rate for each of said one or more other advertisers; providing said adapted forecast response rates to said one or more other advertisers; establishing a balance of total demand for responses to a said sponsored link associated with said at least one keyword and predicted supply of said responses, said predicted supply being determined from said forecast response rate; and allocating said sponsored links for serving to said mobile devices with search results provided in response to search requests using said at least one keyword such that one or more sponsored links from a said advertiser offering a highest payment per response are served at least during one or more times having a highest audience.

Embodiments of the invention employ a number of different concepts. Firstly the concept of time of day (which the skilled person will appreciate, as used in this specification, also includes time of week, month, year and the like) is employed in conjunction with the concept of an audience or number of users at a particular time of day. The audience will vary with time of day, and also with (search) keyword or keywords. Historical data may be available which can be used to determine the audience for a specific keyword, or this may be inferred from more general historical audience-related data. The audience (optionally by keyword) will in general vary continuously throughout a day (week, month or other period) but conceptually, as an aid for an advertiser, in embodiments of the method a set of time slots may be defined or determined from the audience data. Preferably these at least differentiate between peak and off-peak periods of the audience.

Another concept employed by embodiments of the invention is that of charging an advertiser for responses such as click-throughs rather than merely on the basis of predicted audience. However although in embodiments an advertiser is charged by actual results, a price determination mechanism employs competition between different advertisers based upon a forecast response rate for a particular sponsored link associated with a particular search keyword. In more sophisticated embodiments, the wording of a sponsored link may be taken into account as this affects the forecast response rate; this may be implemented by means of a historical prediction based upon a previous response rate for the advert or for a similar advert from the advertiser.

A further complicating factor is that it is generally desirable to be able to provide an advertiser with a budget which will not be exceeded even though a charge is based upon response rate. Thus in embodiments although there is, in effect, a bidding process based upon forecast response rate, there is also an allocation mechanism to allocate one or more sponsored links of a winning advertiser for display at times of peak predicted response rates. It will be appreciated from the foregoing discussion that in embodiments the benefit of an advertiser paying a higher price for a sponsored link is a faster clearing rate and therefore a greater chance of the target response level (budget) being hit but not exceeded. Embodiments of the method may also incorporate a limiting mechanism, where this is thought desirable, to restrict a single advertiser from dominating at one or more times of peak predicted response rate.

As previously mentioned, it can be helpful, in particular for advertisers, to think in terms of time slots, but, if so, it should be appreciated that these are not fixed time slots, or even “slots” at all in the ordinary sense of the word—it is perhaps better to think in terms of an area under a demand curve determined from a predicted audience (for a keyword) and, hence, a predicted response rate. Again it should be appreciated that the bidding process is, in effect, for maximum predicted rate of “clearance”, that is meeting of a budget defined by responses to sponsored links and cost per response, rather than merely for a fixed time slot and estimated audience. Embodiments of the system may be thought of as adaptive (with regard to time of day), competitive (with regard to a price based upon a forecast response rate), and controlled or limited (with regard to actual responses/payment), in embodiments all subject to subdivision (into different operating regimes) by sets of keywords (a set of keywords comprising at least one keyword).

In embodiments the account balance of an advertiser preferably comprises a monetary balance, either debit or credit, and in general, therefore, an advertiser registration system is also provided.

The allocation of sponsored links may be performed in substantially real time, in response to a search request dynamically allocating a next link in a queue based upon advertiser bid (payment) amount. Additionally or alternatively the allocation may be performed ahead of time, for example on a daily basis, to allocate a first plurality of served sponsored links in a determined time slot to a first advertiser, a second plurality in the same time slot to a second advertiser, and so forth, again based upon bid (payment) amounts. It will be appreciated that with this latter approach there are many ways of dividing sponsored links for different advertisers amongst time slots; and, likewise, links may either be served in blocks, or interleaved blocks, or individual links of different advertisers may be interleaved or otherwise multiplexed when sent to mobile devices in response to search requests. Likewise a response to a sponsored link may either comprise activation of the link, for example to navigate to further information on another part of a webpage served to the mobile device to provide the search results together with advertising collateral (“a screenview”), or a visit to an advertiser's website (mobile or otherwise), which may be hosted by a server coupled to the search server, or a response may be defined in some other way, for example as a specific, required user action such as purchase of an item of commerce or service.

In some preferred embodiments the allocating comprises allocating serving of the sponsored links at a given time of day such that the served links comprise links of a plurality of advertisers giving priority to the advertisers in accordance with the relative magnitudes (in monetary terms) of their offers.

The establishing of a balance of total demand with predicted supply preferably comprises repeatedly receiving modified offer amounts from one or more of the advertisers and then providing adapted forecast rates to each of the advertisers requesting display of a sponsored link. An offer (and the adapted forecast rates of response) are preferably allowed to go both up and down. In effect, in embodiments of the method the advertisers “bidding” form part of an all-informed net in which the bid of each advertiser affects the forecast response rates for all the advertisers bidding, at least in respect of the relevant one or more keywords. The forecast response rate for a sponsored link associated with one or more keywords is preferably determined using a history of responses to sponsored links included with search results provided in response to search requests incorporating the one or more keywords, that is, broadly speaking, based upon observed traffic patterns. However in some cases reliable records may not be available for a keyword in which case records relating to one or more related keywords, or keywords in a defined category (including the keyword for which a prediction is desired), or all keywords may be employed.

As previously mentioned preferably an advertiser interface to a system implementing the method is configured to indicate to an advertiser at least peak and off-peak periods of audience (in particular audience for the relevant keyword or keywords). Conveniently this may be expressed in terms of a set of one or more time slots.

Preferably an advertiser is then also provided with a time slot quality indicator dependent upon the forecast response rate for the one or more determined time slots (which may be adapted responsive to other “bids” as described above).

Preferably an advertiser interface further provides a mechanism for an advertiser to input a budget value defining an upper limit of payment by the advertiser over a defined time period (such as a day, week, month or the like) which may be termed a “campaign”. The serving of sponsored links (which may be termed “impressions”), is then preferably responsive to this budget value, in order to limit the sponsored links served (in response to searches including the one or more keywords) in order that the advertiser's budget value is not exceeded. The determination of whether or not the budget value is to be exceeded may comprise recording an actual number of responses (and multiplying by the advertiser's payment by response), but in other embodiments sufficiently accurate value may be determined from the forecast response rate for a sponsored link, and hence predicted in advance. This allows embodiments of the system to pre-allocate the serving of sponsored links amongst advertisers, by time, which can be advantageous. Optionally, as mentioned, an anti-lock out feature may be implemented, for example by limiting a maximum budget value for an advertiser.

In some embodiments the allocating of sponsored links is performed in substantially real time in response to a search query including the at least one keyword from a mobile device. Thus, for example, a search request including a keyword may be received, the keyword may then checked against a database of adverts and keywords to identify one or more sponsored links associated with that keyword. A look-up into a database for a corresponding advertiser may then be performed to determine how many responses for that advertiser have been fulfilled, and whether or not there is capacity in the advertiser's quota (for example daily quota) for more responses (the sponsored link having been selected in the first place on the basis of the advertiser's highest offer of payment). If the advertiser's quota for the period or campaign has not been met then the retrieved sponsored link is served to the search requesting mobile device together with the search results; if not then a sponsored link for the advertiser with the next highest offer is identified and the same check is performed. This process may be continued iteratively until a sponsored link is found or until it is determined, for example, that no sponsored link is to be served. Likewise a response to a sponsored link served in this way may be tracked in real time and recorded in a database, for example for use in a version of the foregoing method. Preferably, therefore, the allocating of sponsored links further comprises maintaining a record of a number of responses served for each of the advertisers having a sponsored link associated with the one or more keywords, during a time period, updating the record in response to provision of search results.

As previously indicated in embodiments of the method link allocation data is maintained, this data defining a division of sponsored links between the advertisers and determining, for a search request comprising a keyword, which sponsored link or links is to be included with the search results. This link allocation data is responsive to the budget value at the forecast response rate. For example, in embodiments of the method the system knows the number of searches performed using the keyword, the number of responses, and the advertisers' budget, and this information can be used to determine the number of “impressions” served. Additionally, rather than count just the number of impressions served, impressions may also be served for a pre-determined time period corresponding to a special peak-time period, for example just before a major football event, when mobile audiences can be expected to be particularly high.

In some preferred embodiments of the method search results are delivered as a package, the package defining one or more “screenviews”, as explained further below.

In a variant of the above described method the invention provides a method of managing sponsored links to be transmitted to the screens of mobile devices in response to search requests from a searcher using a mobile device to access a search engine, online marketplace, or other similar service, the display of these links being matched to geographical location, the method comprising: maintaining records of advertiser accounts for payment for responses to a said sponsored link an advertiser account comprising at least an advertiser identifier and an account balance for each of a plurality of advertisers, sponsored links that correspond to search request keywords, modifiable offer amounts submitted by said advertisers each said offer amount being associated with at least one search keyword, and records of search requests using said at least one keyword and responses to sponsored links included with search results provided in response to said search requests; monitoring an audience for the service, said audience comprising the number of users carrying out searches within a given time interval at a said geographical location; receiving from an advertiser a request for display of a sponsored link in association with at least one said search request keyword and an offer amount, said offer amount comprising an offer of payment for responses to said sponsored link, said offer of payment applying over a time period; forecasting a response rate for a sponsored link associated with said at least one keyword using said records of search requests using said at least one keyword and responses to sponsored links included with search results provided in response to said search requests; adapting said forecast response rate dependent upon a total demand for sponsored links associated with said at least one keyword as determined from said request received from said advertiser and one or more said requests from one or more other said advertisers; responding to said advertiser request using said adapted forecast response rate; determining an adapted forecast response rate for each of said one or more other advertisers; providing said adapted forecast response rates to said one or more other advertisers; establishing a balance of total demand for responses to a said sponsored link associated with said at least one keyword and predicted supply of said responses, said predicted supply being determined from said forecast response rate; and allocating said sponsored links for serving to said mobile devices with search results provided in response to search requests using said at least one keyword such that one or more sponsored links from a said advertiser offering a highest payment per response are served at least for one or more geographical locations having a highest audience.

The invention further provides a system for managing sponsored links to be transmitted to the screens of mobile devices in response to search requests from a searcher using a mobile device to access a search engine, online marketplace, or other similar service, the display of these links being responsive to time of day, the system comprising: at least one records system for maintaining records of advertiser accounts for payment for responses to a said sponsored link an advertiser account comprising at least an advertiser identifier and an account balance for each of a plurality of advertisers, sponsored links that correspond to search request keywords, modifiable offer amounts submitted by said advertisers each said offer amount being associated with at least one search keyword, and records of search requests using said at least one keyword and responses to sponsored links included with search results provided in response to said search requests; an audience monitoring system for monitoring an audience for the service, said audience comprising the number of users carrying out searches within a given time interval at a said time of day; an interface for receiving from an advertiser a request for display of a sponsored link in association with at least one said search request keyword and an offer amount, said offer amount, said offer amount comprising an offer of payment for responses to said sponsored link, said offer of payment applying over a time period; and a processor coupled to data memory and to program memory storing processor control code, the code comprising code for controlling the processor to: forecast a response rate for a sponsored link associated with said at least one keyword using said records of search requests using said at least one keyword and responses to sponsored links included with search results provided in response to said search requests; adapt said forecast response rate dependent upon a total demand for sponsored links associated with said at least one keyword as determined from said request received from said advertiser and one or more said requests from one or more other said advertisers; respond to said advertiser request using said adapted forecast response rate; determine an adapted forecast response rate for each of said one or more other advertisers; provide said adapted forecast response rates to said one or more other advertisers; establish a balance of total demand for responses to a said sponsored link associated with said at least one keyword and predicted supply of said responses, said predicted supply being determined from said forecast response rate; and allocate said sponsored links for serving to said mobile devices with search results provided in response to search requests using said at least one keyword such that one or more sponsored links from a said advertiser offering a highest payment per response are served at least during one or more geographical locations having a highest audience.

The invention also provides a system for managing sponsored links to be transmitted to the screens of mobile devices in response to search requests from a searcher using a mobile device to access a search engine, online marketplace, or other similar service, the display of these links being matched to geographical location, the system comprising: at least one records system for maintaining records of advertiser accounts for payment for responses to a said sponsored link an advertiser account comprising at least an advertiser identifier and an account balance for each of a plurality of advertisers, sponsored links that correspond to search request keywords, modifiable offer amounts submitted by said advertisers, each said offer amount being associated with at least one search keyword, and records of search requests using said at least one keyword and responses to sponsored links included with search results provided in response to said search requests; an audience monitoring system for monitoring an audience for the service, said audience comprising the number of users carrying out searches within a given time interval at a said geographical location; an interface for receiving from an advertiser a request for display of a sponsored link in association with at least one said search request keyword and an offer amount, said offer amount, said offer amount comprising an offer of payment for responses to said sponsored link, said offer of payment applying over a time period; and a processor coupled to data memory and to program memory storing processor control code, the code comprising code for controlling the processor to: forecast a response rate for a sponsored link associated with said at least one keyword using said records of search requests using said at least one keyword and responses to sponsored links included with search results provided in response to said search requests; adapt said forecast response rate dependent upon a total demand for sponsored links associated with said at least one keyword as determined from said request received from said advertiser and one or more said requests from one or more other said advertisers; respond to said advertiser request using said adapted forecast response rate; determine an adapted forecast response rate for each of said one or more other advertisers; provide said adapted forecast response rates to said one or more other advertisers; establish a balance of total demand for responses to a said sponsored link associated with said at least one keyword and predicted supply of said responses, said predicted supply being determined from said forecast response rate; and allocate said sponsored links for serving to said mobile devices with search results provided in response to search requests using said at least one keyword such that one or more sponsored links from a said advertiser offering a highest payment per response are served at least for one or more geographical locations having a highest audience.

According to a further aspect of the invention there is provided a method of responding to a search query from a wireless communications device, the method comprising: determining a collection of search results in response to the search query; determining at least one sponsored link to be included with said collection of search results; packaging said collection of search results with said at least one sponsored link into a data package for display on said wireless communications device; and sending said package to said wireless communications device for display of at least one of said search results together with said at least one sponsored link; and wherein said determining of said at least one sponsored link comprises selecting said sponsored link from a data store comprising a plurality of sponsored links, responsive to a time of day.

As described above, the at least one sponsored link is selected from a data store comprising a plurality of sponsored links, responsive to a time of day, for example, indexed by time. In this way advertising (hyperlinks) may be time-multiplexed although rather than a multiplicity of adverts being downloaded to a mobile device, an advertising (or other) link is served to the mobile device according to time and/or time period.

A sponsored link preferably comprises text, optionally in association with other data such as image data, and also includes a hyperlink. In embodiments the hyperlink comprises a link to a separately displayable part of a single document with the data package or screenview, as described further later. Preferably the one or more sponsored links are relevant to the search query.

In embodiments of the method a sub-section or sections of the mobile search result screen or result webpage is allocated for mobile advertising purposes. Typically this may comprise a header and/or footer section of a displayed page, leaving space in the middle of the page for a search result list, although in mobile devices with a landscape rather than portrait display form factor the left and/or right hand margins of the screen display area may be employed.

Referring again to the time-sharing of sponsored links, as previously mentioned in preferred embodiments sponsored links are displayed in accordance with an allocation procedure dependent on time, more particularly time of day (which includes week, month, year and the like). Preferably space on the mobile display screen and/or sponsored links are sold in a sophisticated variety of auction, as described above, thus allowing multiple advertisers to bid for one or more sponsored links and associated text to be displayed in the aforementioned result screen sections or sub-sections whenever a specific keyword is used as a search term. In embodiments the price varies and may be determined in accordance with an embodiments of a method as described above. Additionally or alternatively the (monetary) value of a sponsored link may depend upon its position within the results display, those which will be seen first having a higher value. In embodiments, for example, one sponsored link is provided for each screenview (up to the total number of screenviews/results displayed), optionally an sponsored link being repeated to populate each screenview with at least one sponsored link.

In embodiments as described above, therefore, a sponsored link may have a monetary value associated with a time of day indexing the sponsored link (although this monetary value need not be explicitly stored in the sponsored link data store). We have already described preferred examples of procedures by which a value may be assigned to a sponsored link, and further details are provided later.

In embodiments of the method the wireless communications device sends type identifier data to the search system, for example, as part of a header for data transmitted from the mobile device. This is employed to determine formatting of the search result and sponsored link data sent back to the mobile device, such as the number of words to display, and therefore the packaging of the collection of search results with the one or more sponsored links is responsive to this type identifier data so that the displayed one or more search results and sponsored link appear in a format suitable for the device. The type identifier data may be employed, for example, to read formatting data from a database; the formatting data may comprise Wireless Universal Resource File (WURFL) data (XML configuration file data with information about capabilities and features of a plurality of wireless devices), or other similar data.

As mentioned above, the packaging optionally comprises defining a plurality of screenviews for displaying the collection of search results, each screenview comprising a substantially complete screen of displayed data for a wireless communications device, and formatting the data package such that when displayed by the wireless communications device at least one of the screenviews includes the at least one sponsored link. Preferably, however, one sponsored link is provided per screenview. In embodiments a screenview comprises at least one hyperlink for intra-package navigating to another of the screenviews of the package. Thus in embodiments each screenview displays a substantially complete screen of data on the wireless mobile communications device but, nonetheless, the screenviews are provided as part of a substantially contiguous markup language document within a single package to the wireless mobile communications device. In other embodiments separate, linked markup language documents or datasets may be provided but nonetheless still within the single package of results data, in order to minimise end-to-end latency effects within the mobile network.

Optionally the packaging of the collection of search results comprises incorporating into the package content summaries of the search results each for display in an aforementioned screenview. In this way one or more sponsored (for example, advertising) links may be interspersed through a content summary package to “stack” sponsored links. Broadly speaking a content summary package (CSP) as used herein comprises a collection of search result summaries or content summary objects, described in more detail later, which can be downloaded to a mobile device in one query-response over a mobile network. This facilitates a user inspecting a number, typically five to 10 of candidate search results without having to make additional, time-consuming requests over the mobile network. Thus in embodiments (sponsored) advertising or other links are inserted into the content summary package, typically as a header or footer of each of the screenviews obtained within the package, so that when a user clicks between screenviews the display moves up and down to reveal the various sponsored links. It will be appreciated that this concept may be used together with or independently from the above described sponsored link time-sharing.

In embodiments the packaging further comprises including advertising material (“collateral”) in the data package for display such that the at least one sponsored link navigates to the advertising material without requiring a further query-response operation across a wireless network connecting the wireless communications device.

This advertising material may be read from a database at the server end and may comprise, for example, text and/or image data with optional internal links/bookmarks, and optionally also external links to further data formatted for display on a wireless device and/or to a conventional non-mobile device website. Preferably each set of such advertising material defines a screenview.

Since an advertiser may not have a website formatted for mobile devices that can be linked to from a sponsored link the invention also provides a search service/server configured to format advertising material (“collateral”) provided by the advertiser and to host this material on behalf of the advertiser in such a way that it is available to the wireless device over the wireless network.

This material (images, text, prices, link and the like) may be supplied to the search service/server in a variety of ways. However in preferred embodiments the search service/server makes available a conventional (desktop) webpage offering one or more templates so that the advertiser is able to use a desktop system to access the searched service and, for example, fill in a web form with data for an advertisement. This may comprise, for example, supplying one or more of images, text, links, and other advertising collateral.

In preferred embodiments the search service/server is able to link from the one or more sponsored links in the search results to these hosted pages of mobile-formatted data (advertisement pages). As described above, in some embodiments these pages may be incorporated into content summary packages (i.e., the larger multi-section pages previously described). In the latter the sponsored link may comprise a bookmark link to another location within the content summary package, so as not to need to use the network for another fetch-response cycle, which could impose a further several seconds delay. Thus, in some preferred embodiments, the package comprises a block of screenviews for displaying advertising collateral (or other material) navigable with intra-package links.

In embodiments the above described hosting of mobile-formatted pages of data for display of advertising (or other) material may be extended so that the search service/server is configured to host an advertising site comprising a plurality of pages/packages of data as previously described. Optionally a complete site may be packaged within a data package as previously described, for example using a content summary page format, for rapid intra-package navigation between pages of the advertising site. In embodiments the advertising site is accessed by clicking on a link to a first advertising page, which sends a URL (or other resource location) request to an advertising (or other) site hosted by the search service.

In addition to static, display orientated content, these hosted advert pages may also offer revenue opportunities, such as:
links that initiate phone calls (whether to zero-rated, normal or premium rated lines—for example the URL may comprise a phone number for dialing by a microbrowser on the mobile device
links that send preformatted SMS (short messaging service), MMS (multimedia messaging service) or other messages (where supported by handsets), these might be used to buy ringtones, vote in TV shows, enter multiple-choice competition and the like
links that stimulate a server to send SMS' or other message/connection types (to compensate for devices that do not support direct sending of SMS and the like), for example by detecting at the server end a “click-on” by a user of the mobile device. This server may be the mobile search service server or a third party server.
links to URLs under the control of a user's Network Operator, e.g. for top-up and for Network Operator services/advertising.

Hosting these pages on a server has the additional benefit of concentrating the distribution of Network Operator deals—without this centralisation, advertisers would have to each make their own commercial arrangement for the hosting of content on a mobile site with an Operator.

Preferably the package comprises a markup language document such as HTML (Hyper Text Markup Language), XHTML, DHTML, or the like, which may be viewed with a standard microbrowser on the mobile device. In other embodiments the package may comprise application data for implementation by a (custom) client application running on the mobile device. In this latter case when the data package is loaded onto the mobile handset the client application provides substantially equivalent functionality as described above to a markup language-based system without relying upon, say, a XHMTL. In other embodiments the package may comprise a combination of a markup language document and custom client code (e.g Javascript) which can be interpreted by a browser application.

In a related aspect the invention provides a computer system for responding to a search query from a wireless communications device, the system comprising: a search system interface for sending said search query to a search system and for receiving a collection of search results in response to the search query; an advert storage system interface for receiving advertising data comprising at least one sponsored link to be included with said collection of search results; a wireless network interface for receiving and responding to said search query from said wireless communications device; data memory for storing data for packaging; program memory storing processor control code; and a processor coupled to said search system interface, said advert storage system interface, said wireless network interface, said data memory and said program memory, to load and implement said control code, said code comprising code for controlling the processor to: obtain a collection of search results in response to the search query; obtain at least one sponsored link to be included with said collection of search results; package said collection of search results with said at least one sponsored link into a data package for display on said wireless communications device; send said package to said wireless communications device for display of at least one of said search results together with said at least one sponsored link; and wherein said code to obtain said at least one sponsored link comprises code to selectively retrieve said link via said advert storage system interface responsive to a time of day.

The invention further provides processor control code to implement the above-described methods, in particular on a data carrier such as a disk, CD- or DVD-ROM, programmed memory such as read-only memory (Firmware), or on a data carrier such as an optical or electrical signal carrier. Such a carrier may, as appropriate, be included within a mobile device or server system.

Code (and/or data) to implement embodiments of the invention may comprise source, object or executable code in a conventional programming language (interpreted or compiled) such as C, or assembly code, code for setting up or controlling an ASIC (Application Specific Integrated Circuit) or FPGA (Field Programmable Gate Array), or code for a hardware description language such as Verilog (Trade Mark) or VHDL (Very high speed integrated circuit Hardware Description Language). As the skilled person will appreciate such code and/or data may be distributed between a plurality of coupled components in communication with one another.

We also describe a carrier carrying a data package responding to a search query from a wireless communications device, said data package comprising a collection of search results in response to the search query and at least one sponsored link to be included with said collection of search results.

Optionally the data package comprises data defining a plurality of screenviews for displaying the collection of search results, each screenview comprising a substantially complete screen of display data for the wireless communications device such that, when displayed by the wireless communications device, the one or more sponsored links are arranged for display one per screenview.

We further describe a method of providing content formatted for a wireless communications device, the method comprising: providing a user interface comprising at least one template for content data entry; inputting said content data from a user using said template; formatting said content data for said wireless communications device; and hosting said formatted content data on a server on behalf of said user.

Preferably the formatted content data comprises markup language data. Preferably the hosting further comprises adapting the content data for presentation on the wireless communications device in response to type identification data received from the wireless communications device.

We still further describe a method of displaying a plurality of sponsored links together with a plurality of search results on a mobile device, the method comprising: displaying said search results in a plurality of screenviews each corresponding to substantially a full display screen of said mobile device; and displaying one of said sponsored links on each said screenview.

Preferably the method further comprises providing data for the screenviews to said mobile device as a package including advertising content, the advertising content comprising a said screenview, at least one of said sponsored links linking to the advertising content comprising said screenview.

The invention further provides a method, carrier or system as set out in any one or more of the claims in which any or all of the mobile or wireless device or devices mentioned are replaced by wired or wireless entertainment and/or computing terminals.

### BRIEF DESCRIPTION OF THE DRAWINGS

These and other aspects of the invention will now be further described, by way of example only, with reference to the accompanying figures in which:

FIGS. 1a to 1d show, respectively, an overall block diagram of a system according to an embodiment of the invention, a flow diagram illustrating operation of a preferred embodiment of the system, a flow diagram of an example procedure for implementation on a campaign server of the system, and an example block diagram of a campaign server for the system;

FIGS. 2a to 2c show further example embodiments of systems according to the invention;

FIGS. 3a to 3d show example screenviews of data displayed on a mobile device within an embodiment of a system according to the invention, each including a clickable sponsored (advertising) link;

FIG. 4 shows an example Campaigns screen display;

FIG. 5 shows an example Ads screen display;

FIG. 6 shows an example Campaign statistics screen display;

FIG. 7 shows an example audience statistics report screen display;

FIG. 8 shows an example advertiser account statement screen display;

FIGS. 9 and 11 shows an example sequence of events;

FIG. 12 shows an example package of content summaries;

FIG. 13 shows an arrangement for generating content summaries including sponsored links for a query server; and

FIGS. 14 and 15 show example screenview packages.

### DETAILED DESCRIPTION OF THE PREFERRED EMBODIMENTS

Outline Description

It is helpful for understanding some preferred embodiments of the systems we describe to appreciate the three following notions:

The notion of relevancy: the tight linkage of sponsored links to search requests i.e the advertiser pays to have the sponsored links displayed only when the user enters a specific search keyword or keywords.

The notion of bid amounts submitted by advertisers linked to specific keyword(s).

The notion of competition for limited (sets of) available times for display of sponsored links associated with specific keywords, and the allocation process of sponsored links into these slots being determined by value of each advertiser's bid amount, which is held in a database within the system. For popular search query keywords, there will be multiple advertisers wanting to associate their sponsored link with that keyword. The advertiser with the highest bid for the keyword gets priority placement at peak period times, but once their monthly quota has been spent, the next highest bidder then gets priority, until all budgets for that keyword have been exhausted and then no ads are displayed, irrespective of time of day.

Broadly we will describe a system and method for managing the display of sponsored links transmitted to the screens of mobile devices in response to search requests from a searcher using a search engine, online marketplace, or other similar service, with the display of these links matched to peak and off-peak times, for example, time of day (which includes time of week, month, year; or available, adaptive timeslots).

Embodiments of the system maintain a database of advertiser accounts, search request keywords, sponsored links that correspond to these keywords, and optionally available times or timeslots for display of sponsored links, together with modifiable bid amounts submitted by advertisers, these amounts being associated with at least one search keyword. Preferably (but not essentially) an offer of payments applies over a time period.

Over time, the system monitors the number of users (i.e. the user ‘audience’) carrying out searches in any specific timeslot within a given time period (or, more generally, a search rate, where in effect a timeslot becomes vary short so that a continuously varying distribution may be tracked) both in general for all searches and for searches conducted with specific keywords.

Working together with a search engine (which may be an integral party of the system, or may be provided and hosted by a 3^{rd} party) the system determines a relevant set of search results in response to the search query keyword. It also determines a set sponsored links from advertisers to be displayed adjacent to or included within the search result list on the screen of the mobile device. For popular search keywords, these advertisers may be competing with each other to display links in response to the same search query keyword.

From this set of sponsored links determined by the system, the system selects one or more links to be displayed at specific times (for example in specific, adaptive timeslots), in order of the highest bid amount to the time (or timeslot) with the highest user audience. It then packages collection of search results and the selected sponsored link(s) into a data package for display on the screen of the mobile device.

A sub-section (or sections) of the mobile search result screen or result web page is allocated for mobile advertising purposes. Typically this would be the header and/or footer section of the page, leaving space in the middle of the page for the search result list. In mobile devices with a landscape (instead of portrait) display form factor it could alternatively be the left or right hand margin of the screen area.

These sections are then ‘timeshared’ so that multiple advertisers can bid for their sponsored links and associated lines of text to be displayed in these sub-sections whenever a specific keyword is used as a search term.

Timeslots to enable this timesharing may be categorized as peak and off-peak, and a system may also allow advertisers to bid for specific timeslots (preferably information is presented to an advertiser in timeslot terms, although the system itself need not employ these timeslots when allocating sponsored links) where their ads appear at specified times during the day. This is done by giving the user the option to pay a premium on its bid amount for a sponsored link to be displayed in a specific timeslot that might be expected to have particularly large user ‘audience’. The level of this premium is set by reference to previous records of user search frequency in these timeslots kept by the system.

The system is able to detect when a user clicks through from a sponsored link to the web site destination address referenced by this link. This may be a direct click-through event, or an indirect one going first to a different screenview on the same page displayed on the mobile device and then to the external web site address (see improvement in Section below) When the user clicks through in this way on a sponsored link provided by an advertiser, the system debits the advertisers account by the bid amount.

When the debits reach a maximum limit set by the advertiser (which may be an absolute limit, or a limit set by time period e.g. 1 month), no more sponsored links will be displayed for that advertiser, (or for that advertiser in that time period, if the spending limit is set for a time period) until the account is replenished.

Advertisers may log onto the system at any time via a secure authentication process, using a web browser or alternative software application to access the user interface of the account management aspects of the system. They may view summary charts and other statistical records showing the frequency of users' searches on the system, either for all searches or for searches conducted with specific keywords. Advertisers may enter new bids for keywords, set new monthly (or other time period) spending limits, modify their bid amounts substantially in real time, and remove bids for keywords.

Using existing secure payment systems, the system may pre-pay a specified amount of expenditure on sponsored links. Alternatively, using existing credit verification systems, the system may authorize a specific credit limit with the advertiser being invoiced later for payment. Advertisers may view summaries of their spending on keywords and their remaining account balances

Description of Topology

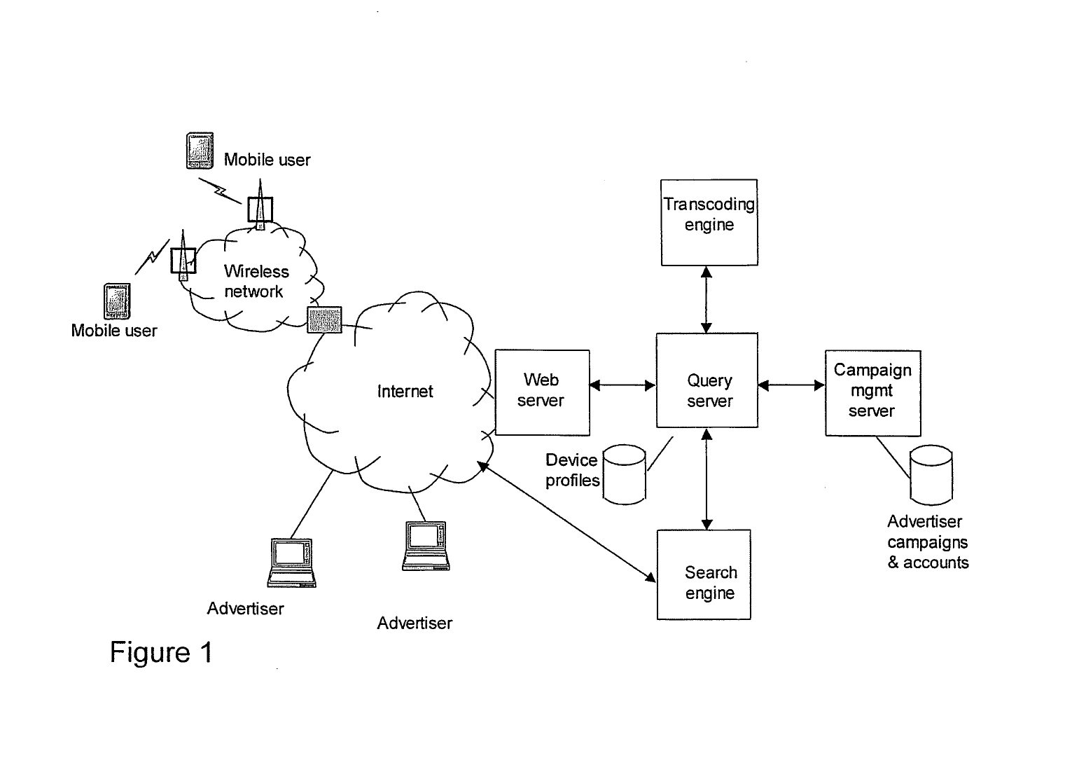

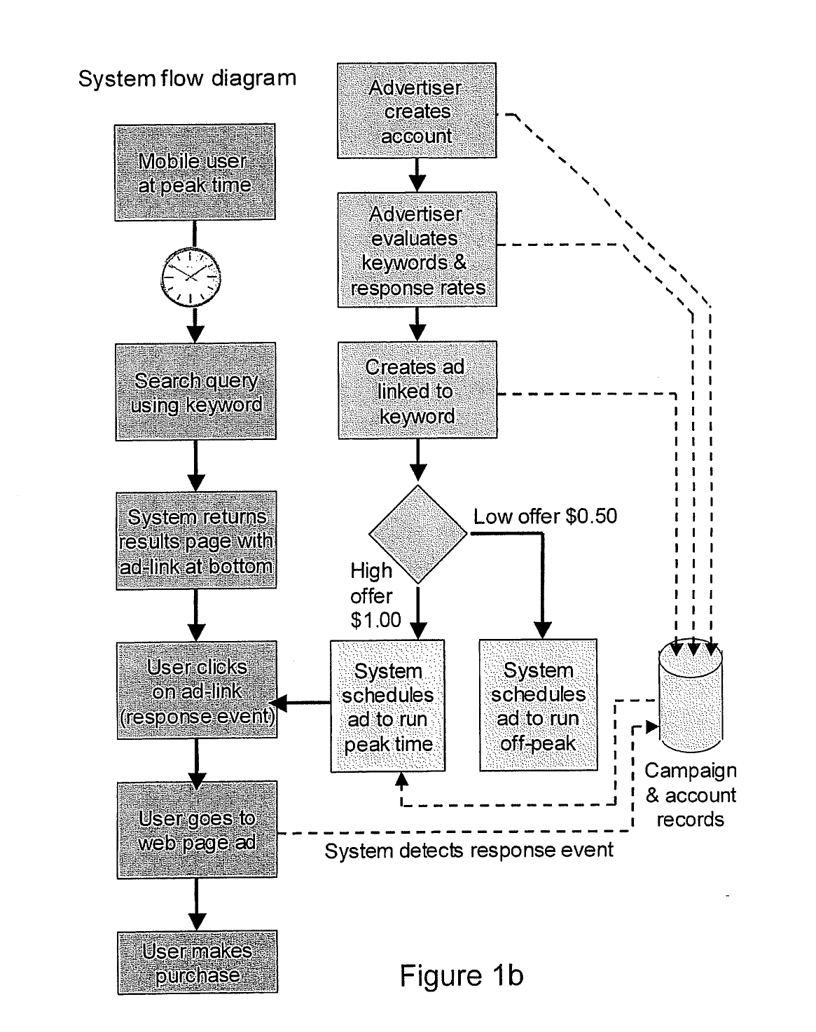

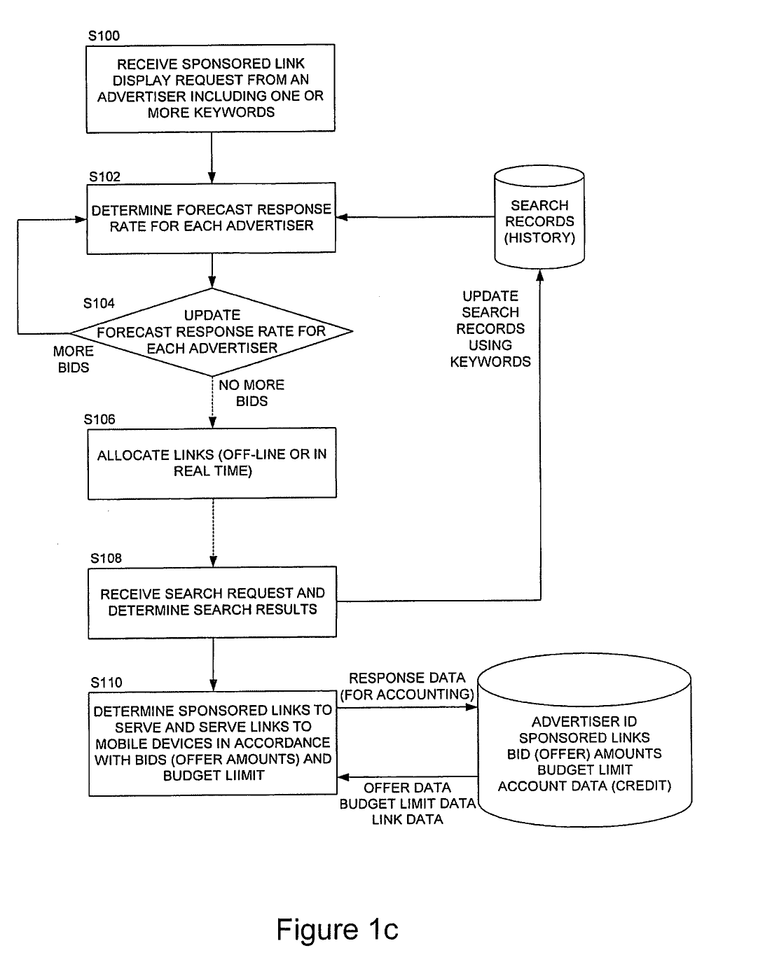

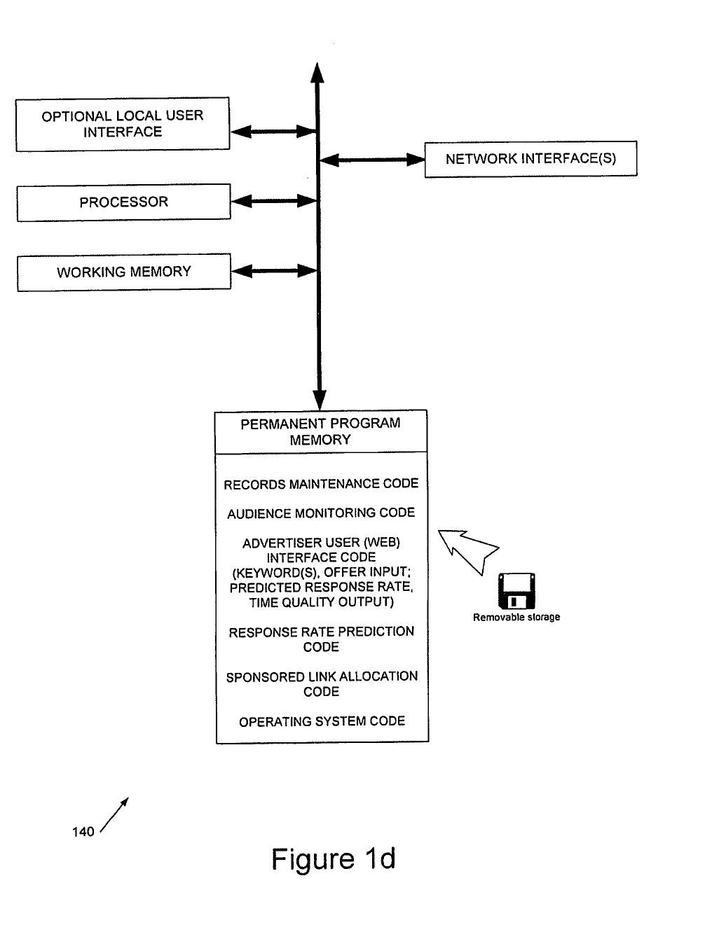

We first describe an example overall topology of the system, as shown in FIG. 1. A query server, account management server and search engine server are connected via a web server to the Internet. A plurality of advertisers seeking to promote their goods or services maintain web sites hosted on web servers which are also connected to the Internet. A plurality of users making searches (‘mobile users’) on mobile devices are connected to a wireless network managed by a network operator, which is in turn connected to the Internet via a WAP gateway, IP router or other similar device. The mobile devices are typically phone-like handsets communicating over a wireless network, but may be any kind of wirelessly-connected mobile devices including PDAs, notepads, point-of-sale terminals, laptops etc. Each device comprises one or more CPUs, memory, I/O devices such as keypad, keyboard, microphone, touchscreen, a display and a wireless network radio interface.

These devices can typically run web browser or microbrowser applications e.g. Openwave, Access, Opera browsers, which can access web pages across the Internet. These may be normal HTML web pages, or they may be pages formatted specifically for mobile devices using various subsets and variants of HTML, including cHTML XHTML, XHTML Basic and XHTML Mobile Profile. The browsers allow the users to click on hyperlinks within web pages which contain URLs (uniform resource locators) which direct the browser to retrieve a new web page.

Depending upon the capability of the browser or microbrowser running on the device, the mobile device may be able to view the web site of the advertiser directly, or may need to access this site via a transcoding engine connected to the query server. If the advertiser has created mobile-specific web pages able to be more easily viewed across a wider range of mobile devices, then the mobile device will be able to view the advertiser web site directly, even if the device has a lower capability microbrowser.

Turning next to the servers, there are five types of server in one preferred embodiment of the system:

A web server that connects the overall system to the Internet

A query server that handles search queries from mobile devices, passing them onto the other servers, and formats response data into web pages customised to different types of devices, as appropriate

A search engine server that handles requests for keywords and matches these keywords via an index to web pages on the WWW.

A campaign management server controlling and managing a database containing advertiser campaign and account information.

A transcoding engine server, which in response to clicks on sponsored links by a mobile user displays a web page formatted to match the level of browser functionality running on that mobile device.

The web server is a multiplicity of physical servers, set up in a fault-tolerant configuration, running Apache or some similar program, handling multiple simultaneous HTTP and FTP communication protocol sessions with users connecting over the Internet.

The query server is connected to a database that stores detailed device profile information, including information on the device screen size, device capabilities and in particular the capabilities of the browser or microbrowser running on that device. The database may also store individual user profile information, so that the service can be personalised to individual user needs. This may or may not include usage history information.

The search engine server takes as its input a search query request from a user, and returns as an output a prioritised list of search results. Relevancy rankings for these search results are calculated by the search engine by any of a number of alterative techniques already known in the art.

The search result list is accompanied by one or more sponsored links pointing to advertiser web sites, these sponsored links being located on specific display regions on the mobile device screen. The integration of the sponsored links and search results into a package which can be transmitted to the mobile device is done typically by the query server, which communicates with the campaign management server to match the search query keywords with keywords bid on by advertisers in campaigns (although it may be done by a modified version of a search engine server, communicating with the campaign management server).

The campaign management server contains a database which stores advertiser campaign and account information. This server, like the search engine server and query server is protected from intrusion via a firewall system (not shown). Advertisers can create and manage accounts on this server, using a normal web browser running secure communication protocols such as SHTTP and SSL. Accounts are password protected, with a program running to check that the user has not selected an insecure password (e.g. only letters, only a few characters).

The transcoding server is like the query server connected to a database of mobile device profile information. In embodiments this may be the same database, shared between these two servers. The transcoding server is used to mediate the display of information between advertiser web sites and mobile users' devices, in those circumstances where there is a mismatch between the formatting of the web site content and the format handling capabilities of the specific microbrowser application running on the mobile device.

FIG. 1b shows a flow diagram illustrating operation of a preferred embodiment of the system. FIG. 1c shows a flow diagram of an example procedure for implementation on a campaign server of the system, and FIG. 1d shows an example block diagram of a campaign server for the system.

Referring to FIG. 1b, this shows two processes: a mobile user searching using a keyword and getting a results page back that includes sponsored links (shown as ad-links in the diagram), and an advertiser creating an account and then creating an ad-link together with an ad.

The mobile user process flow starts with the user initiating a search using the mobile device at a peak time during the day. The search is initiated using a specific keyword, and the search engine system returns a results page to the user which includes not only a list of search results but also an ad-link located at the bottom of the first results page or screenview.

When the user clicks on the ad-link, which is defined as the response event in this particular embodiment of the system, the browser then loads (in this case, over the wireless network) a web page ad provided by the advertiser. This particular ad-link was selected for display to the user by the search engine system because the advertiser had bid a high offer, $1.00, sufficient to ensure that the ad-link was displayed to search users at a peak time rather than an off-peak time of the day. After viewing the web page ad, the user subsequently decides to make a purchase (e.g. concert tickets) from the web site.

The advertiser process flow starts with the advertiser creating an account. An account record is then set up in the campaign and account records database. The advertiser then evaluates particular keywords which will let him or her focus on particular groups of user at which he wants to target promotional messages. On entering a candidate keyword, the advertiser is given response rate forecasts based on the previous system history of numbers of searches and responses for that keyword. These forecasts allow the user to select an appropriate keyword, and create an ad which he can link to that keyword.

If the advertiser makes a high offer for the keyword, in this case $1.00 per response, then the search engine system schedules the ad to run at peak audience time. If the advertiser makes a lower offer for the keyword, e.g. $0.50 per response, then the system schedules the ad to run later at an off-peak audience time. Our example mobile search user, who is using the system at peak time, will only see the ad-links that are scheduled by the system to appear at peak time.

If and when the user clicks on the ad-link the search engine system detects this response event, and records it in the campaign and account records database. The advertiser account is then debited by $1.00, and the system stores both the keyword query event and the ad-link response event in its database of event records (not shown).

Calculation of Forecast Response Rates

We now describe one example of a calculation of forecast response rates for the above procedure. The skilled person will appreciate, however, that alternative techniques may be employed.

The system maintains a record of all search keywords or combinations of keyword entered by users over time. For example, for the search keyword ‘Beyonce’ (i.e. the name of a well-known music artist) the system has counted 3500 queries using this word in isolation in the last month, August, and a further 1500 queries where ‘Beyonce’ is used in combination with other keywords, making 5000 queries in all. The response rate of users clicking on Ad-links in search results returned in response to these queries was 10% i.e 500 responses. Of these responses, 400 were made in what the system calculated as peak-time periods of the day, and 100 were made in off-peak times.

In this example, let us assume that there are 10 advertisers (selling, for example, Beyonce concert tickets and merchandise) who all wish to create Ad-links and ads that are displayed in response to ‘Beyonce’ queries. Let us assume that the base price, or starting price for a response to a ‘Beyonce’ query is $0.50. Each advertiser would like to spend up to $100 per month to get up to 100 responses to their ads.

If all 10 advertisers open an account with the search engine service on the last day of August, and just stick with the default base bid price of $0.50, then the system analyzes the monthly traffic on the Beyonce search term and sees that there were 500 responses in the last month and so forecasts 500 responses in September (using the simplest possible forecasting rule in this example, that the next month will equal the previous month). The responses that are allocated in September will have to be divided up between 10 advertisers, so the forecast response rate per advertiser is 50 responses each for the coming month, and the forecast budget spend per advertiser per month is $25.

One advertiser, advertiser A, who is disappointed with not being able to guarantee 100 responses, decides on September 1st to increase their bid price to $1.00 per response. As a result the system prioritizes responses to this advertiser, increasing the forecast number of responses to 100, and reducing the forecast available quota of responses to the other advertisers to 400. These responses will have to be divided up between the 9 advertisers who have kept their bids at the base price, $0.80, so the forecast to each of these advertisers is now 400 divided by 9 i.e. 44.4.

Calculation of Time Quality Estimates

Continuing with the above example, we next describe calculation of time quality estimates. At the point in time where all 10 advertisers were bidding the base price, $0.50 per response, the system was forecasting 50 responses each. From its records on Beyonce search history, it knows that 400 out of 500 responses last month were in peak time and 100 in off-peak time. It can then calculate that for each advertiser it can forecast 40 responses in peak time, and 10 responses in off-peak time. For this particular system, 100% of responses forecast in peak time equates to a time quality score of 2.0 and 100% responses forecast in off-peak time equates to a time quality score of 1.0. As a result, it forecasts a Time quality score of 1.8 for each advertiser, since 80% of forecast responses will be in peak time for all advertisers.

When advertiser A increases his bid on the ‘Beyonce’ keyword to $1.00, the system priorities his responses to appear before responses to other advertisers in peak time. There are 400 available forecast responses in the month in peak time for this keyword, and advertiser A only needs to be allocated 100 responses. So the system updates advertiser A's forecast Time quality score to 2.0. There are 300 forecast responses remaining in peak time, and 100 in off-peak time, to be allocated between the remaining 9 advertisers. The system recalculates their Time quality scores, forecasting a Time quality score of 1.75 for each of these 9 advertisers, since 75% (i.e. 300 out of 400) of their responses will be in peak time.

Search Systems

We next describe some examples of query-response search systems in the context of which embodiments of the system may operate. We will describe the basic search systems, and then associated features which may be used by example embodiments of the invention.

It is important to understand that, although it may be convenient, there is no need to use a Content Summary Package (CSP) as described below, to implement systems with the sponsored link time-sharing concepts described herein.

Some examples systems we describe involve browsing results of a search query by receiving results on a wireless device in the form of a package (a “Content Summary Package”) which can include a content summary for each item of the search results, including multimedia items and a number of other features to make browsing more rapid or convenient, especially to overcome physical limitations of handheld mobile devices with limited capabilities for display or for scrolling or selecting, and the physical limitations of the wireless network. The package can be arranged as a page extending over a number of browsable screenviews. This can provide more information and/or a more convenient arrangement for browsing, compared to the normal annotated result list provided by traditional search engines. The quantity and presentation of the summary of each content item can be tailored to suit the device to best take advantage of the mobile device physical format. For example each content summary could be arranged to fill a small format screen of a handheld mobile device. The content summarized can be Web pages, news items, sound or video clips or many other types of content for example.

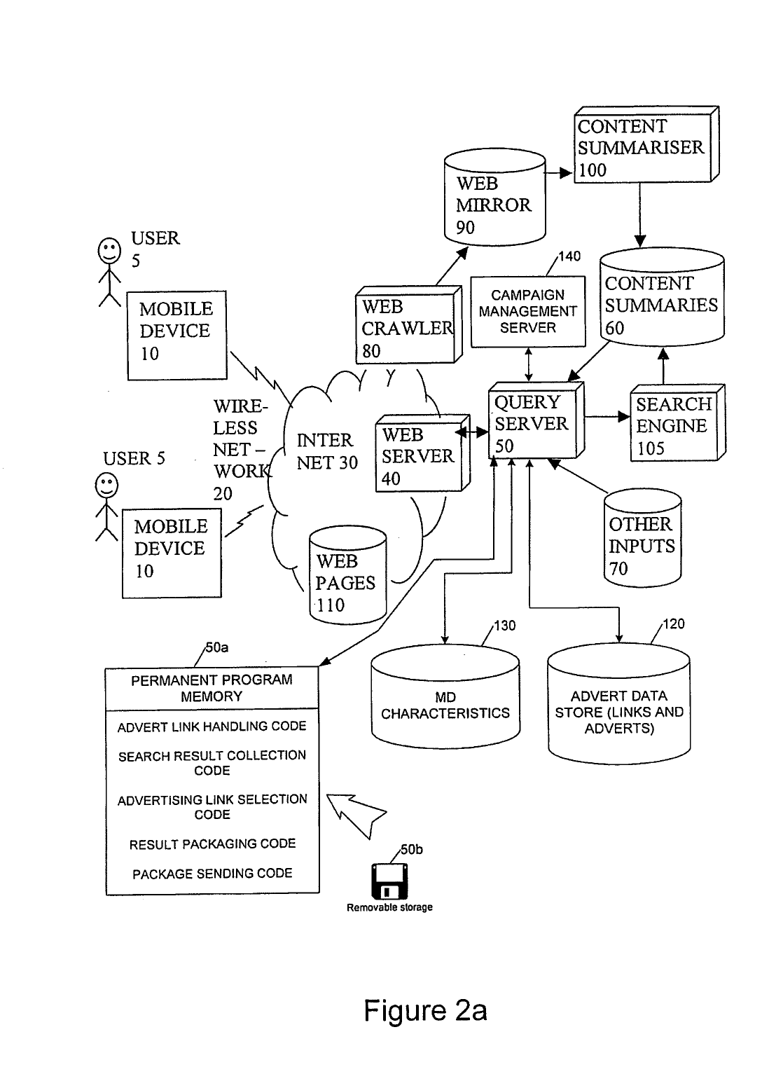

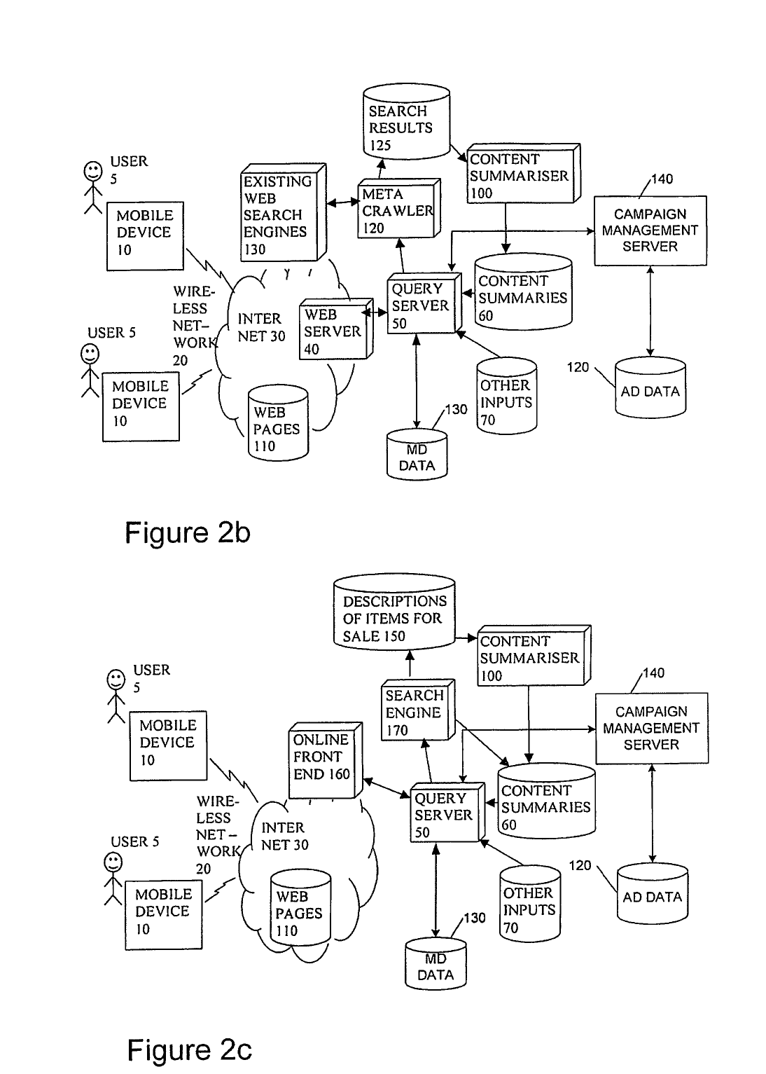

Referring to FIG. 2a, this shows the Internet 30, and two mobile devices 10 of end users 5, coupled to the internet over a wireless network 20. In principle, the mobile devices could be coupled to other applications, for example in car computers with voice interfaces to enable users to search and obtain information from the web while driving. In FIG. 2 cylinder symbols represent stored information such as databases which may be implemented on a hard disc or in semiconductor memory for example, and may be distributed or local, and may be managed with appropriate back up and access security, following established practice. Cuboid shapes in this figure represent processes which may run as application software on their own server or be distributed or may share a server for example.

The search query is typically one or more keywords sent by the browser to the known internet address (URL) of the query server. It is sent as a request and is sent via a conventional protocol stack in the mobile device to enable communication over the wireless communications network. The protocol stack typically comprises the standard WAP or TCP/IP protocols which allow the mobile device to communicate with internet hosts and the transport and physical layer protocols, for example GPRS or the third generation UMTS protocols, that enable the mobile terminal to access and communicate data over the wireless communications network. The mobile terminal establishes a communications link to a WAP gateway or network access server (NAS) that interfaces the wireless network to the internet and routes the browser's request across the internet.

The query server 50 is coupled to the internet via a web server 40. Search queries are received by the query server and passed to a search engine 105 for searching for relevant content summaries in a content summary database 60, managed by the search engine. Optionally the query server can operate as a front end only, in which case it could select a search engine of another organization at a remote location, which would use a content summariser and store of content summaries of that other organization or location. The functions remain similar wherever they are carried out or by which ever organization. Optionally the query server can be located at the interface between the wireless network and the internet, and be part of a service provided by the wireless network operator. The relevant content summaries are returned to the query server and formed into a package suitable for browsing on the mobile device of the user. Other inputs 70 are fed from a store to the query server for use in forming the package. Such other inputs can include advertising or news material for presenting to the user, or characteristics of the mobile device or its browser, characteristics of the wireless network channel, user location, user preferences and so on, for use in determining how much to send, and in what format and so on. The query server sends the package via the web server, the internet and the wireless network to the mobile user.

A content summariser 100 is provided to build up the database of content summaries. A web crawler 80 searches the world wide web via the internet 30 to assemble a copy of web pages in a web mirror, which is then accessed by the content summariser 100.

FIG. 2b shows another example search system having some similar features to FIG. 2a, and corresponding reference numerals have been used as appropriate. In this case, the content summaries are created on demand by processing the search results coming from an existing search engine. The query server passes the query to one (or more) search engines. The search engine then operates in the normal way to retrieve a results list in response to the search query. The content summariser builds its summaries by following the links to web pages from URLs in the results list, loading these web pages, and processing them to extract the appropriate summary information. In the case where the query server is passing the query to multiple search engines, it is acting as an enhanced metacrawler which is carrying out an additional content summarization step when compared with existing metacrawlers.

FIG. 2c shows another example search system, also having some similar features to FIG. 2a, and corresponding reference numerals have been used as appropriate. In this case, the search is of items for sale via an online store or marketplace, and content summaries are created on demand or off line, or some combination. An online front end 160 to the store or marketplace, (such as Ebay™ or Amazon™) receives a search query for an item. This could be direct from the user, or from an intermediary service which searches many on line stores or marketplaces for example. The front end passes the search query to the query server 50. This could be arranged so that all search queries are handled by the same query server, or the front end might distinguish those from mobile devices over a wireless network and just pass those to the query server. This manages the search by passing the query to a search engine 170 arranged to search either or both of a database 60 of content summaries, and a database 150 of information on items for sale. In the latter case, results are passed to a content summariser 100 and content summaries are stored in database 60 as before. Relevant content summaries, are fed from the store to the query server for packaging and sending to the mobile device.

Referring again to FIGS. 2a-2c, these also each an advertising database 120 coupled to query server 50 storing advert pages and/or sites as well as advert (hyper)links, for serving mobile device formatted sponsored adverts as well search results in response to query results. A Mobile device database 130 is also coupled to query server 50 to provide information to server 50 for formatting the advert data, for example to determine the number of words to display. This information may comprise screen size and/or other mobile display characterising data for the MD 10 requesting the search. A header received from the MD 10 can be used to identify the type of MD, and this may be used to index database 130.

In preferred embodiments the query server includes non-volatile program memory 50a storing code for advert link handling, including code to obtain a collection of search results in response to a search query, code to obtain at least one sponsored link to be included with the collection of search results, code to package the collection of search results with the one or more sponsored links into a data package for display on the mobile device, and code to send the package to the mobile device for displaying the search results and advert link(s), for example using a microbrowser. This code may be provided on a carrier medium, illustratively shown by disk 50b.

In preferred systems an advert account management server manages a bidding process for timeshared advert sections so that multiple advertisers can bid for their sponsored links and associated lines of text to be displayed in these sub-sections whenever a specific keyword is used as a search term. This is described further later.

Placement of Sponsored Links

As previously described, there is insufficient space on the screen of a mobile device to display a list of sponsored links on the screen at the same time as the search result list requested by the user. Any bidding system which relies on paying for placement in a list of sponsored links is no longer viable. This has the effect of significantly reducing the revenue available to the mobile search engine service.

As the capabilities of mobile devices improve in the future, the size of mobile displays and the number of pixels contained within these displays will both increase. This will free up more space that can potentially be reserved to display sponsored links. However, the need to carry around these devices easily is likely to restrict the physical size of the device for the foreseeable future. As a result there will always be significant less space available for display of sponsored links than there is with a desktop search engine service.

Embodiments of the invention work by reserving specific sub-sections within the search results page for sponsored links, sections that are easily visible to the user when search results are being viewed. Typically this would be a visible header and/or visible footer section of a mobile web page, leaving space in the middle of the page for the search result list. In mobile devices with a landscape (instead of portrait) display form factor it could alternatively be the left or right hand margin of the screen area.

These sub-sections of the results page are necessarily small in area, significantly restricting the number of sponsored links that can be displayed, and therefore the number of advertisers that can advertise. The invention deals with this key constraint in the following way. If more than one advertiser bids for a sponsored link associated with a specific search keyword, then the system allows both advertisers (or a multiplicity of advertisers) to share the screen area reserved for sponsored links by a process of timesharing. Timeslots may be categorized as peak and off-peak, and a system may also allow advertisers to bid for reserved timeslots where their ads appear at specific times during the day.

Where more than one advertiser has bid for a sponsored link associated with the same search keyword, the system resolves the conflict by first of all allocating the timeslots with the highest value (i.e. peak period timeslots) to advertisers that have bid the highest amount for that keyword or combination of keywords. When the allocated budget of that advertiser is exhausted (e.g. when the spend on that campaign has reached a designated monthly limit), then the timeslots are allocated to the advertiser that has bid the second highest amount for that keyword. This process continues until the budgets of all advertisers that have bid for that keyword are exhausted, after which no more ads are then displayed. From the perspective of the mobile advertiser, we are providing a ‘bid-for-peak-time’ system.

The system may optionally allow a maximum level of usage to be set for each timeslot for any individual advertiser e.g. 75% to prevent monopolisation of that timeslot by that advertiser.

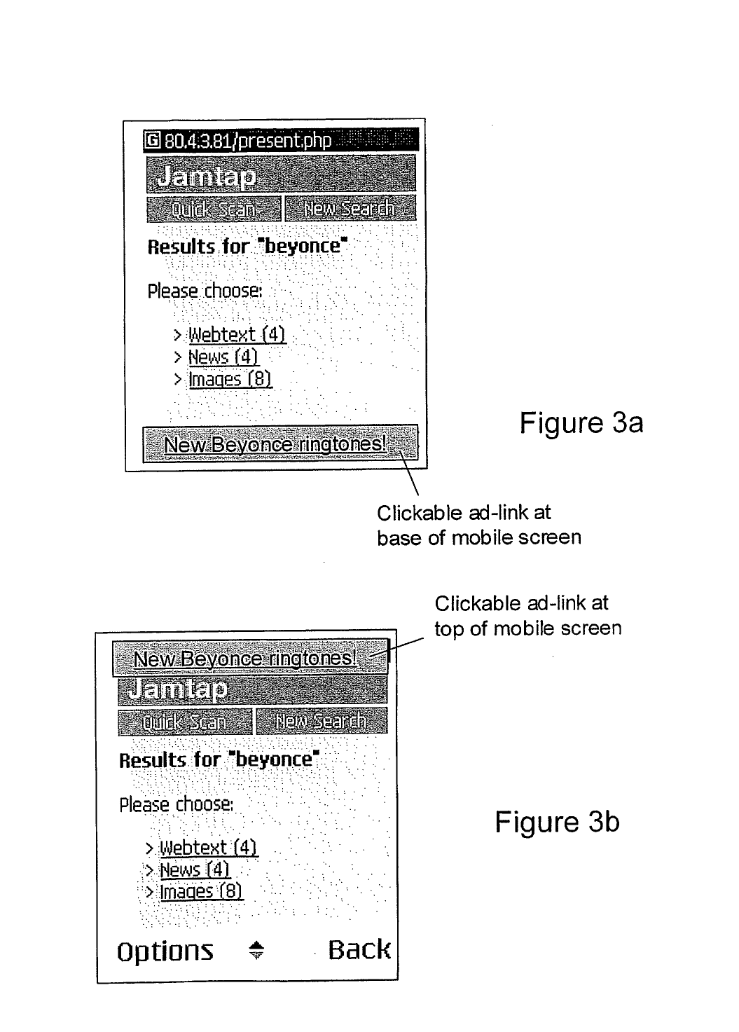

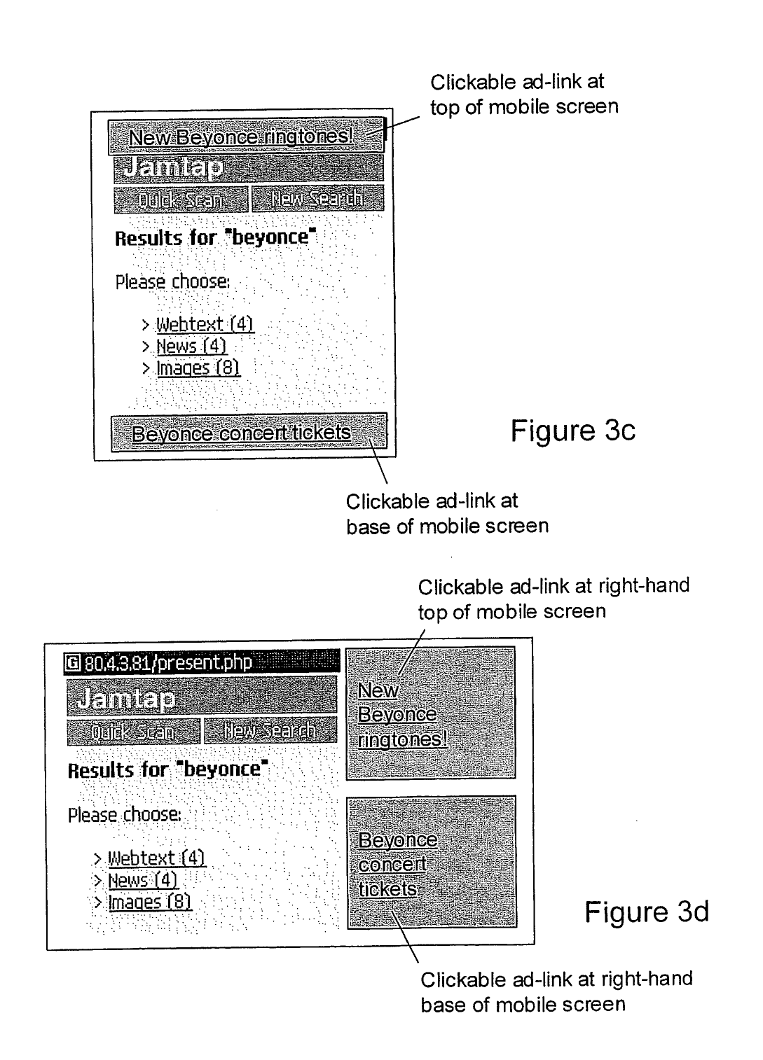

FIGS. 3a to 3d shows several examples of content screenviews which could be found for the example by keyword “Beyonce”, each including a clickable Beyonce-related advert link. In FIGS. 3a to 3c these are at the bottom, top and top and bottom of the mobile device screen respectively; in FIG. 3d they are at the right hand side of the screen.

Description of User Roles in the System

The following types of user are envisaged:

Mobile users searching for specific information or content (e.g. travel directions, wallpapers & ringtones to personalise their handset).

Advertisers with web sites wishing to promote their goods or services. The actual user is usually a professional with some specialist knowledge in web marketing. He or she may work directly for the advertisers or alternatively may be an external consultants or an external professional working in-house for a specialist agency.

Administrators, generally working for the company operating the mobile search system, who administer a multiplicity of advertiser customer accounts, to ensure the smooth running of the system.

Description of Tasks Performed in Embodiments of the System

The following tasks are implemented, on one or more servers, in some preferred embodiments of the system:

a) Account management

a. Create account (contact and billing information)
b. Edit account
c. Request account statement
d. Delete account
e. Administer accounts
   i. Add money to account (via validation step)
f. Event notification
g. Help on account management
   B) Campaign management
a. Create campaign
b. Create ad
   i. View keywords (showing current max bid, other stats, suggestions of alternative keywords)
   ii. Create ad
   iii. Make bid—enter max CPR (Cost per Response)
   iv. Assess ad placement
   v. Predict ad spend
   vi. Run ad (via checking process to check ad conforms to policies)
   vii. Pause ad
   viii. Resume ad
c. Edit ad
   i. Edit ad details (including add or delete search keyword)
   ii. Change max CPR (assess new ad placement, predicted ad spend)
d. Delete ad
e. Edit campaign details
f. View campaign results
   i. View by campaign
   ii. View by ad
g. Delete campaign
h. Campaign event notification
i. Help on campaign management
   c) Statistics and reporting
a. View campaign stats
   i. Ad stats for this campaign by specified time period
   ii. Keyword stats for this campaign by specified time period
b. View audience stats
   i. Audiences by time general
   ii. Audiences by time by category of search
   iii. Audiences by time by keyword
c. View account stats
   i. Performance data across all your campaigns over specified time period
d. Request account statement
   i. View debits and credits to your account over specified time period
      a) Account Management
Account management is the area of the system where user accounts get set up and managed. The general principle is that of a self-service system i.e. the user is responsible for carrying out most of the main account management tasks and actions within the system. This is the part of the system where user (typically user=organisation and the name of a person) contact information and billing information is stored and managed. It is also the starting point for a new advertiser who needs to set up an account for the first time.
   a. Create Account (Contact and Billing Information)
      Creating an account requires the user to enter an preferred user name and preferred password, which is then validated to check that it is sufficiently secure. This allows the user to be logged onto the system and identified so that they can go to the next step. After creating their account they are prompted for an initial monthly spending limit which they would like to set.
   b. Billing
      Here, the user selects their preferred type of payment (e.g. credit card, debit card, credit account with invoices, bank transfer prepayment) and is presented with Terms and Conditions of service which they can either agree to or exit the task. If agreed, they then enter appropriate contact details (e.g. person name, email address, phone number, company name, address, city, country, postcode) and optionally some profiling details (role in company, type of company, how did you hear about service). Once funds transfer from the financial intermediary has been notified to the system, they have a positive funds balance in their account, and it is then activated.
   c. Edit Account
      This is where the user can change certain contact and billing details.
   d. Delete Account
      This is where the user can request to close down an account. He is then given the choice of how any remaining funds in his account will be paid back to him.
   e. Administer Accounts
      i. Add money to account (via validation step)
         The user can top us his account at any time by going through a similar process to that described above under Billing. For pre-paid customers, money must be put into the account before ads can be run. Top-ups can be via credit card, debit card or bank transfer. Certain customers may be given the option to open a credit account, in which case they have a pre-set monthly spending limit which they can apply to increase once they have shown a good credit record with the service provider.
   f. Event Notification
      Certain events (e.g. the account running low on funds, the arrival of funds from the account holders bank by direct transfer) will trigger the transmission of a mail message to the named contact person linked to the account.
   g. Help on Account Management
      Help and guidelines on operating the account is provided electronically by the system.
         b) Campaign Management
This is the core of the system for the user. It is where day-to-day advertising activity is managed under the umbrella of an overall campaign.

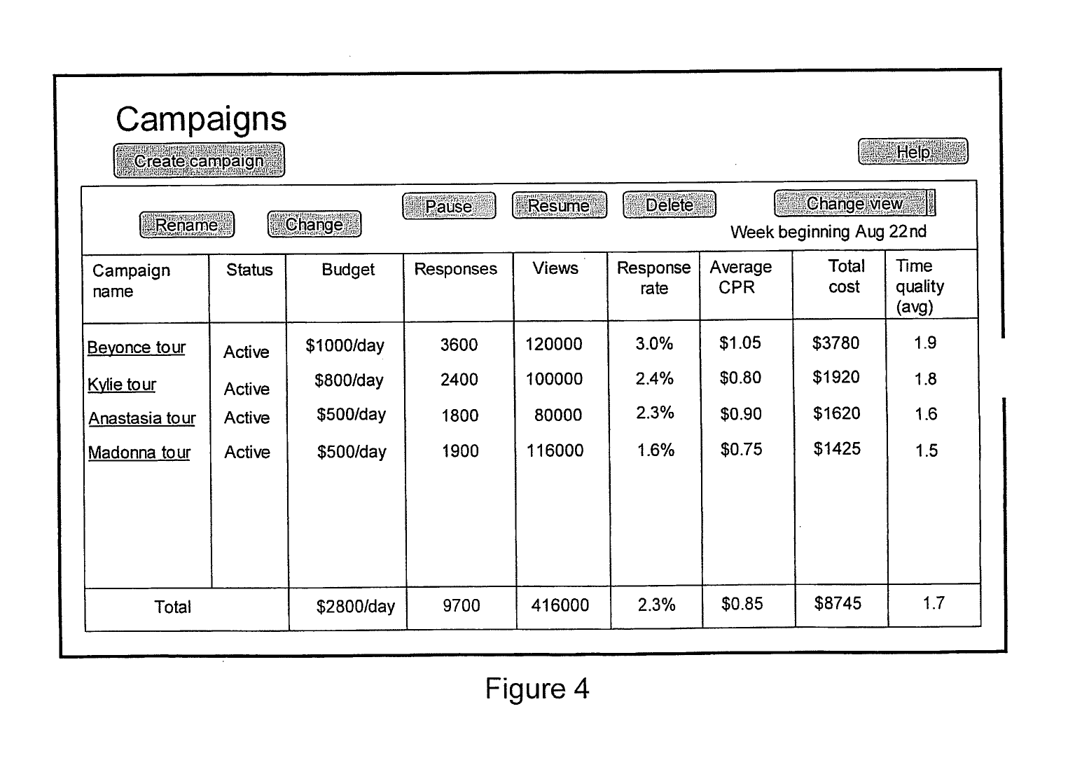

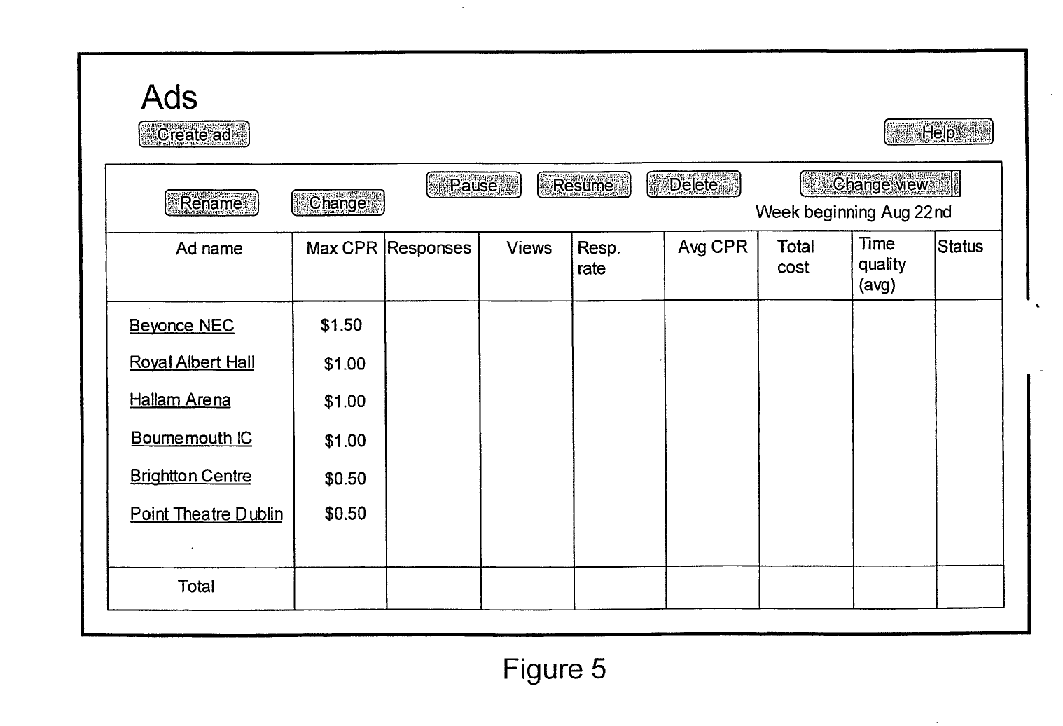

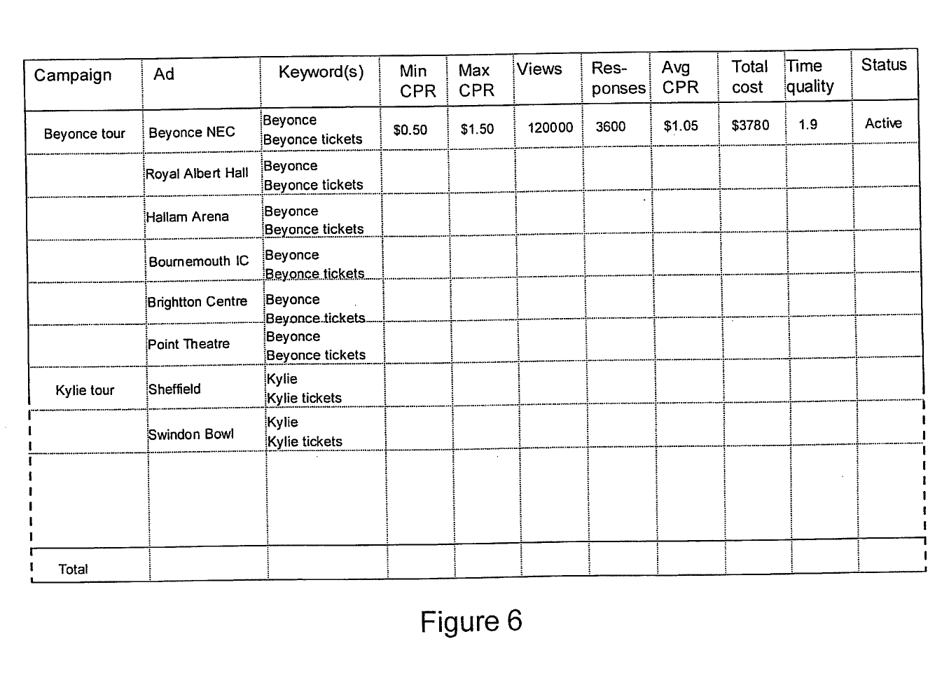

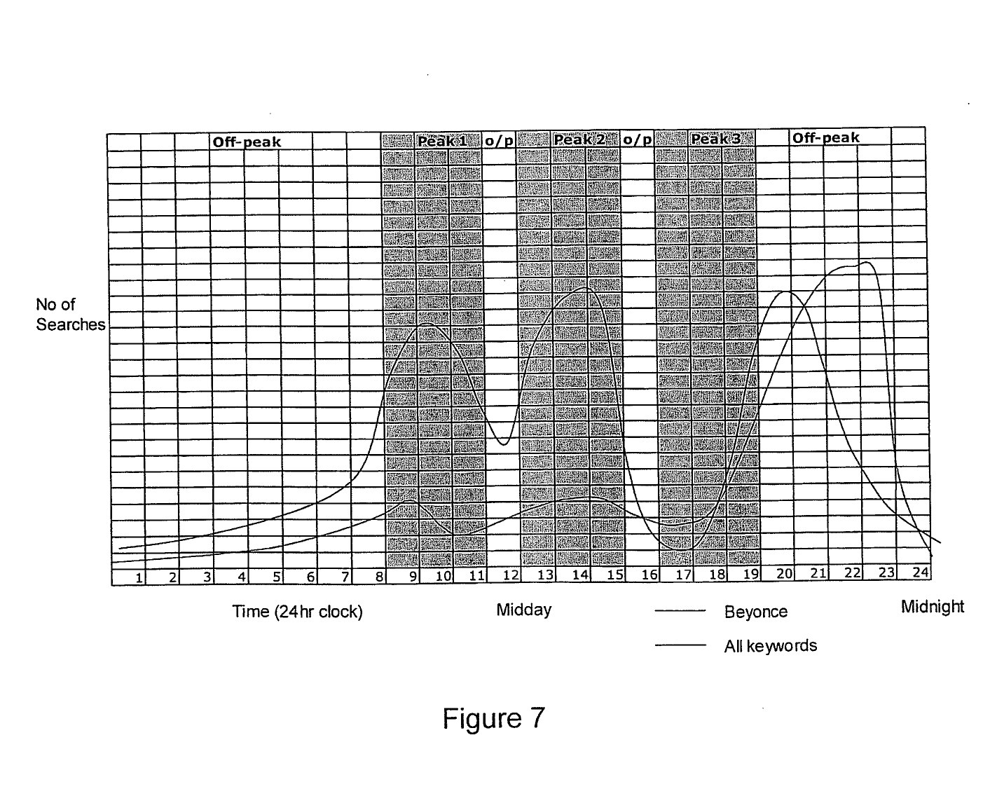

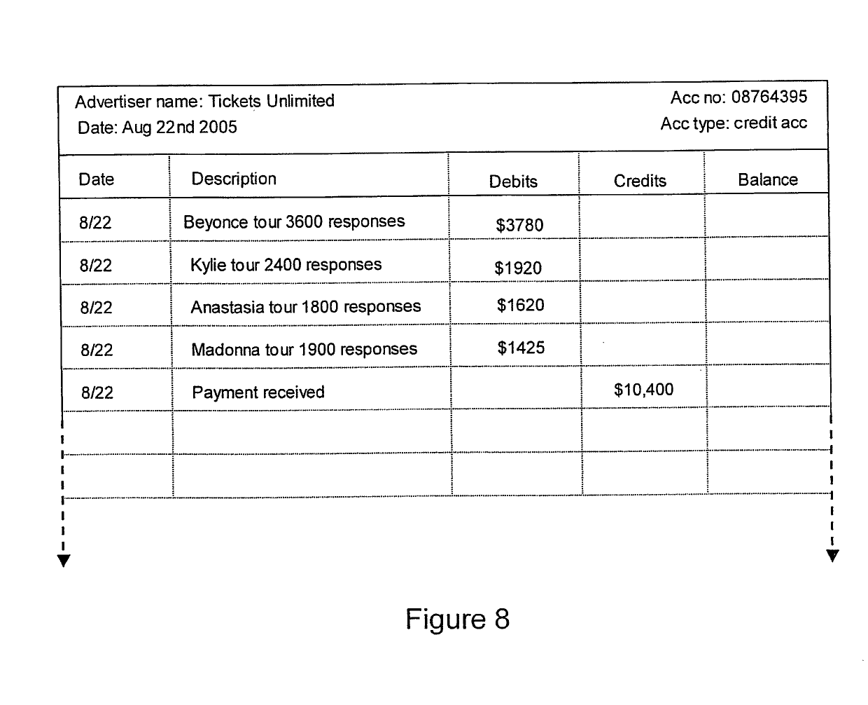

FIG. 4 shows an example Campaigns screen display, which provides an advertise user interface, for example over the internet.
a. Create Campaign
   The advertiser is prompted to enter the name of a new Campaign, and optionally some targeting information (e.g. country or region to target—as handsets add better location-based capability this targeting will be able to get better and better)
b. Create Ad
   This is where the individual ad intended for display on the mobile device is created. A form is provided for the advertiser to specify the name of the Ad, the headline (which cannot be longer than can be displayed on one or two lines of a mobile handset screen), a destination URL, and optionally an Ad-page which is descriptive text up to a single screenview of the mobile device. Once the advertiser is happy with the layout of the ad, he presses a button on the form to save the Ad. The ad is then checked automatically by the system to make sure if conforms to certain rules and policies set by the mobile search service provider (e.g. no profanity, no use of other people's registered trademarks without permission)
      ii. View Keywords (Showing Current Max Bid, Other Stats, Suggestions of Alternative Keywords)
         The ad must be targeted at a specific keyword or keywords that correspond to search queries entered by mobile users. The advertiser enters their desired keyword into a box and the system shows how many searches per day are being carried out using this keyword. On request the advertiser can obtain a graph showing the distribution of these searches over different times of the day, days of the week, and days of the month. The advertiser can request a list of alternative similar keywords and phrases that are being used in searches by mobile users. For each keyword or combination of keywords, the advertiser can determine the current minimum cost per response to use that keyword, and the maximum cost per response that has been bid by other advertisers.
      iii. Select Category
         Optionally the advertiser can select a preferred content category or categories e.g. News, Images, Webtext so that his ad is displayed only in this category in response to a search request.
      iv. Make Trial Bid—Enter Max CPR (Cost Per Response)
         When the advertiser is happy with their selection of keywords they can make a trial bid. This is a tentative bid that allows the system to predict how many responses he is likely to achieve through users clicking on the sponsored link when it is placed at the time of day corresponding to the amount of money that the advertiser is prepared to pay per response.
      v. Assess Predicted Ad Response
         After making the trial bid, the user is shown at which times of the day their ads are likely to be placed, given their bid amount, and the number of likely responses from mobile users.
      vi. Predict Ad Spend
         The spending rate per day, week or month is calculated from the number of predicted responses to the ads over time. The advertiser can see how long his allocated monthly budget will last before it drops to zero.
      vii. Run Ad
         Once the advertiser is happy with both the wording of the ad, the expected response profile and the expenditure profile of the ad, he selects a start date/time and a finish date/time for the ad to run. He then clicks on a ‘submit’ button which launches the ad into the system. Once the start date/time is reached, the advertisers' sponsored links will start to be shown to mobile users who are searching using that keyword(s) as the search term. Advertisers may optionally be given the option to fix the time period during the day (week, month) which their ads run, subject to them having bid a large enough CPR to be able to display in that time.
      viii. Pause Ad
         For any individual ad, the advertiser can pause the ad at any time without losing it from the system.
      ix. Resume Ad
         For any paused ad, the advertiser can resume running the ad. He is asked for a new start time and finish time.
c. Edit Ad
   i. Edit Ad Details (Including Add or Delete Search Keyword)
      Inevitably advertisers are going to want to experiment with different variations or treatments of their ads, both in wording, keyword targeting and placement. The Edit ad function lets an advertiser edit any or all of these, then get a new predicted response rate and spending profile, then if they wish submit the new ad variant to go live on the system. New ad variants are stored and listed in the system under the original ad, so that they can easily be found.
   ii. Change Max CPR (Assess New Ad Placement, Predicted Ad Spend)
      For any existing ad, the advertiser can change their CPR bid, either increasing or decreasing it. As they make and submit these changes, the system shows the impact of the change in terms of predicted response rates and spending rates at the new level of max CPR.
d. Delete Ad
   This function allows the user to delete any ad from the system completely. This aspect of the system works in a non-real-time basis. The ad doesn't stop running immediately, but stops within e.g. 10 minutes to an hour of making the change to allow time for internal databases in the system to be updated.
e. Edit Campaign Details
   Using this function, the advertiser can change the name of the campaign, the daily or monthly budget, the start and end dates, and the regional targeting of the campaign.
f. View Campaign Results
   As a campaign proceeds it is important for advertisers to get feedback on spending, response rates and cost per response. This is provided in summary format in the main Campaigns and Ads screens (see FIG. 5 for an example). More detail, especially on the number of responses in different time periods, can be obtained by clicking on a Results detail button to get to the Results detail screen
g. Delete Campaign
   This button allows an entire campaign to be removed from the system. When this is done, all ads within that campaign are automatically deleted.
h. Campaign Event Notification
   The advertiser is notified by email whenever critical campaign-related events occur. Examples include the time when the campaign starts, when it finishes, and when the daily, weekly or monthly spending limit is reached.
i. Help on Campaign Management
   Help and tutorials on running campaigns are accessible through the Help button in the Campaigns screen.
      c) Statistics and Reporting
a. View Campaign Stats (See FIG. 6 for an Example)
   i. Ad Stats for this Campaign by Specified Time Period
      Allows the advertiser to get a report of the number of responses for his selected ad and keyword(s) (y axis) by time (day, week, or month) (x axis). Also a tabular report is available which can be downloaded in Excel, csv, cdf, xml formats. Can be analysed by different search categories e.g. Webtext, News, Images etc.
   ii. Keyword Stats for this Campaign by Specified Time Period
      Gives the advertiser a report of the total number of responses (y axis) over time for his keyword selection relative to other keywords or combinations of keywords used by searchers (time=day, week or month, x axis). Tabular report also available. Can be analysed by Category.
b. View Audience Stats (See FIG. 7 for an Example)
   i. Audiences by Time General
      Gives the advertiser a report of the total number of responses (y axis) across all keywords by time (day, week or month) (x axis). Data is expressed as a percentage of the level of a previous time period (e.g. January 2005=100) so as not to disclose vital information to competitors. Tabular report also available.
   ii. Audiences by Time by Category of Search
      Same as above except analysed by Category.
   iii. Audiences by Time by Keyword
      Gives the advertiser a report of the total number of responses (y axis) to specific keywords or combinations of keywords by time (day, week or month) (x axis). Tabular report also available. Can be analysed by Category.
c. View Account Stats
   i. Performance Data Across all Your Campaigns Over Specified Time Period.
      This is just a summary of separate campaign reports already described above.
d. Request Account Statement
   i. View debits and credits to your account over specified time period. This looks similar to a bank statement (see FIG. 8 for an example). It defaults to a 1 month report but you can set it weekly, biweekly, monthly or quarterly.
      Example End-to-End Walkthrough

We next describe an example end-to-end walkthrough for a mobile user wishing to personalise their handset

The mobile user (let's call him John) has 5 spare minutes while waiting in the supermarket checkout queue. John wants to personalise the idle screen of his handset with a Beyonce image. He picks up his handset and activates the browser application, selecting it from the main menu of the handset. From the bookmarks list, he selects ‘Jamtap’ and the Jamtap home page loads in a few seconds. He taps out the word ‘Beyonce’ in the search box, clicks on the search button, and waits several seconds for the search query results set to be returned to his screen.

When it arrives, the results set is categoried into News, Images, Webtext, Audio, Sport and Local. As well as these 6 categories, there are three sponsored links from advertisers. Two are from ringtone vendors, and one is from a ticketing agency selling tickets to the next Beyonce concert.

John clicks on the Images category, and is presented with 8 different thumbnail images of Beyonce. These images have been trawled from the World Wide Web by the search engine server. He picks the one he likes best, and then clicks on it to download a new XHTML page over the air, which presents him with a series of cropping options that allow him to pick an image in which Beyonce's head and shoulders fits perfectly into the wallpaper screen dimensions of his handset. He then clicks Download, and the image is downloaded onto the memory card in his handset, where he then sets it as wallpaper.

While he was doing this, John noticed that there was an ad for a Beyonce concert that he was interested in going to. Clicking the back button on his browser, he finds the sponsored link at the bottom of the Images thumbnail screen and clicks on it to get a screenful of information on the concert ticket prices. The ticketing company is a reputable one, and they still have availability, so he clicks on the buy button. This response event is redirected via the mobile search system's servers to the ticketing company's web site (optionally via a transcoding engine, depending on the capability of John's handset browser) where he is able to complete the purchase transaction and charge it to his credit card account.

The ticketing company then send an electronic record of the purchased ticket, with a unique ID code, to John's email address where he can print it out later. Just like an electronic ticket to a low-cost airline, John is able to use this to get into the concert.

This response click through to the mobile search system's servers is detected by the Campaign Management server, where it shows up in the campaign records for the ‘Beyonce NEC tickets’ campaign (see FIG. 6), along with tens of thousands of response events from other users. A significant proportion of these response clicks and arrivals at the ticketing website are being converted into actual ticket sales, as measured by the advertiser. Since the ticketing company has only had to pay for actual response events resulting in a visit to its web site (and not for the display of ads which didn't result in response events) it is very pleased with the results of the campaign.

Terminology

We next explain some terminology as it relates to preferred embodiments of the system, although the descriptions below are intended to aid in understanding the invention and should not be construed as explicitly limiting the spirit and scope of the invention as defined in the claims.

Account (May Optionally Include Sub-Accounts for Larger Advertisers)

An account is the arrangement or facility at the mobile search engine service, arranged for the benefit of the advertiser, that enables the placement of mobile ads and commercial transactions associated with this to be initiated and completed.

Campaign (May Optionally Contain Sub-Campaigns within Hierarchy)

An organised set of planning and execution activities to achieve a particular mobile advertising response generation objective.

Ad

A sponsored link visible to users of the mobile search system, which promotes goods or services provided by the advertiser, and which allows users to click through to advertisers' web pages.

Ad-page

A page, comprised of a screenview of more of information on the mobile device, which is loaded when a user clicks on a sponsored link.

Ad-site

A specially optimised set of web pages, packaged for transmission to the mobile device as a Content Summary Package in a single shot process over the air. Users can navigate through these pages on the mobile device without having to incur the time delays of over the air network latency.

Clicks

An event where the user moves his cursor or joystick to highlight a button, link or sponsored link on a mobile web page, then presses down to make a positive selection. Clicks can be categorised as ‘cheap clicks’ which click through to a bookmark on a different region or screenview within the overall web page (with little time delay, because no over-the-air latency is incurred) and ‘expensive clicks’ which are transmitted over the air to a web server and are then acted on (with significant time delay, because of the over-the-air latency effects in wireless networks)

Responses

A response is when a click by a user results in a click event being transmitted over the air to the mobile search query server, where it can be acted on by the system. The mobile advertiser is more interested in responses, because they can be detected and tracked by the mobile search system, than in clicks—which can't always be detected (because they might be cheap clicks).

Views

Views, which we also refer to as impressions, are a measure of the number of times that a sponsored link is displayed on the device screen in front of the mobile user. Whether this sponsored link is clicked on is another matter.

Cost Per Response (CPR)

The cost in monetary terms to the advertiser for each response event received by the system. A minimum CPR is set by the system, and the advertiser can bid above this to get more favourable placement at busier times of the day. (The system may set the actual CPR lower than the maximum bid CPR and just above the 2^{nd} highest bid to reduce the risk to the advertiser of bidding too high).

Click Rate

The ratio of the number of Clicks (cheap clicks+expensive clicks) to the number of Views.

Response Rate (Equivalent to CTR)

The ratio of the number of Responses to the number of Views.

Further Background to the System

We next describe some examples of systems in the context of which embodiments of the invention may operate. However embodiments of the invention may also operate in other systems, different to those described below.

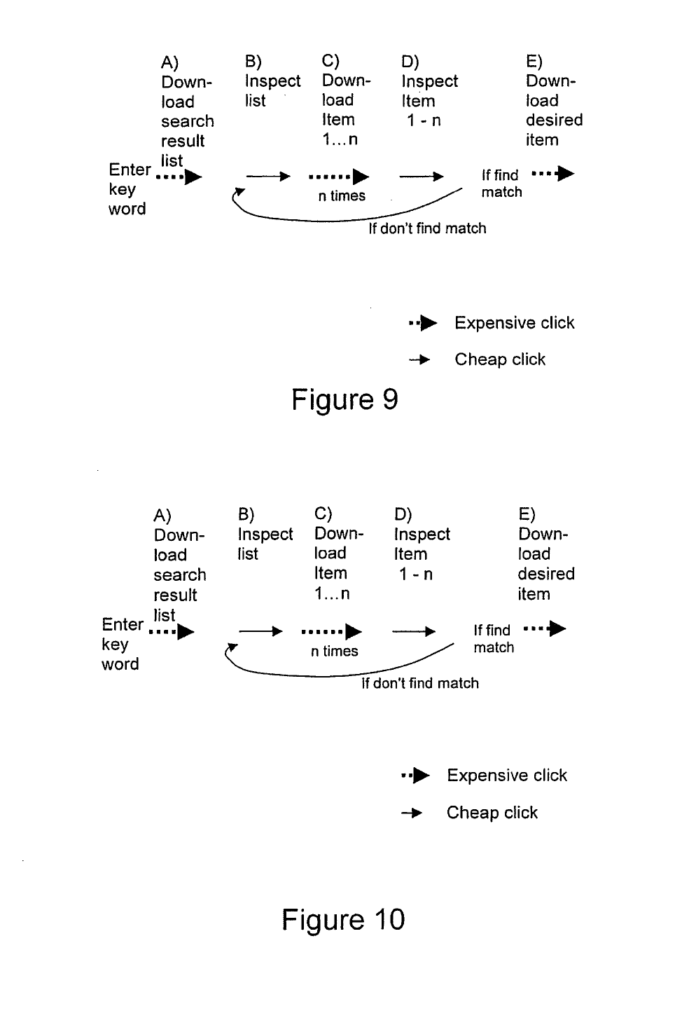

FIGS. 9 and 10 show schematically a sequence of events according to a less preferred method and to a preferred method of accessing data from a mobile device respectively. In both cases, a dotted line arrow indicates a user input such as a click which is expensive in terms of response time. A solid arrow represents a user input such as a click which is cheap in the sense of not incurring delays from query and response operations over the wireless network.

In FIG. 9, after a keyword is entered, this click causes at step A, a search result list including one or more time-shared adverts to be downloaded across the wireless network to the user. At step B, the list can be inspected and a selection made. This click results in a download of an item of content at step C. At step D this item of content can be inspected. Typically it will not be exactly what is required. These steps C and D may need to be repeated until the user is confident that the correct or best item has been found. Step E represents the desired item being downloaded.

In FIG. 10, a keyword as entered as before, and in this case, a package of content summaries is downloaded, including one or more time-shared adverts and/or advert pages and/or advert sites comprising multiple advert pages having a common owner or controller. At step B, an overview is inspected, and from this a choice is made to inspect a selected summary. This uses a cheap click (cheap in terms of time incurred) as shown. It can be repeated many times, to present different screenviews without the inconvenience of response delays, as shown at step C. Once a match or best match is found, at step D, the desired item is downloaded in full. Thus as can be seen, the browsing loop of reviewing the summaries for a match no longer contains the time-expensive click, so such browsing can be accomplished more quickly and conveniently. In other words this means:
1) the user can determine which of the search results is useful, prior to requesting the entire content item (which may be an advert), by first inspecting a summary which is longer than the normal 10 to 20 word summary of the item contained within a mobile search engine results list, without having to suffer the time delay latency effect of the wireless network. In this way a user can quickly determine which search results are useful before having to incur the long time delays of making subsequent requests for content items over the wireless network.
2) The user spends less time in searching for information or content items because fewer requests over the wireless network are required before the user has high confidence that he has found a useful result.

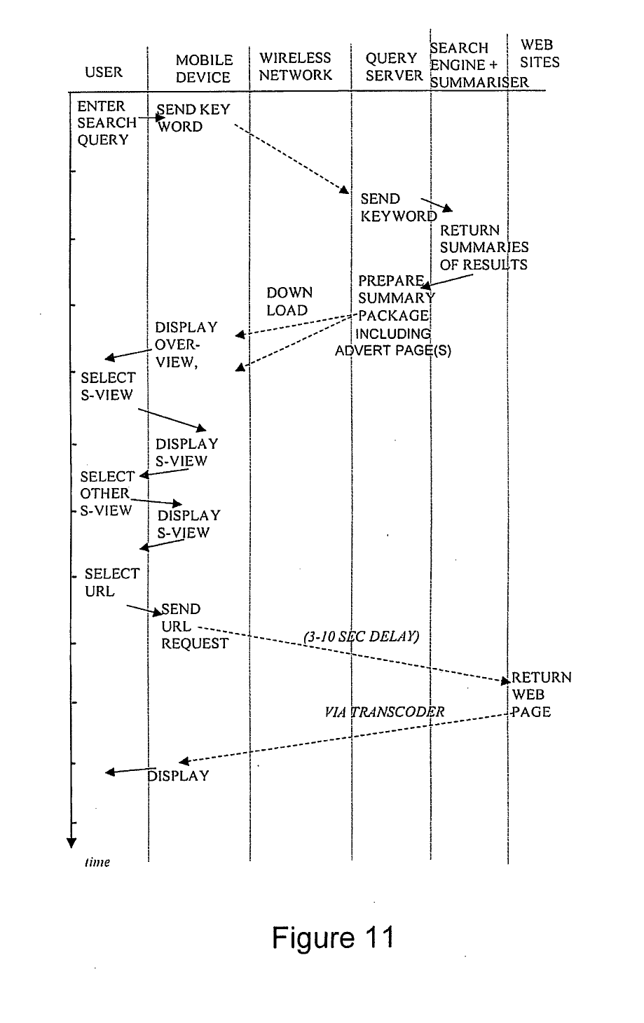

FIG. 11 shows a sequence chart of actions of various entities with time flowing downwards.

A user enters a query into the mobile device (in principle the query could be entered elsewhere such as a desktop computer, for sending results to the mobile device). The mobile device sets up a path for the query and response operation using e.g. WAP or TCP/IP protocols with the query server. This typically involves an exchange of many low level messages, adding to the delay or latency of the wireless network. This enables the keyword to be sent to the query server, which communicates with a search engine to return results in the form of titles, URLs and text extracts having the keywords. However preferably these results are sent to the mobile device as content summaries.

The generation of these content summaries can be carried out offline or on demand, or some combination of these options. If done offline, they can be stored in an indexed database which is integrated within an overall search engine architecture, so that the summaries may be more rapidly retrieved in response to a user query. If the summaries are generated on demand, this requires following the links in search results obtained from existing search engines, to obtain the whole content items, such as web pages. The system can optionally be set up as a metacrawler acting as a front end to existing search engines. The summaries can then be created from the whole content items obtained from multiple search engines.

In one example case the search engine searches an indexed database of content summaries and returns relevant content summaries to the query server. The query server prepares the package of summaries (examples are described below), and downloads it to the mobile device across the wireless network. The mobile device displays the first screenview of the package which is an overview screenview in this case. This may occur while other screenviews are still being downloaded, as shown by the second dotted line arrow at this point. A user can select another screenview to cause one or more of the content summaries to be presented. This browsing can be repeated until the user finds a summary which suits then they can select a URL to request the whole content item, usually via a transcoding engine if the mobile device has a small screen size. Alternatively the user can request more content summaries be sent, or can retry the search with different keywords for example.

In another example content summaries are prepared on demand. In this case a query server implemented as part of a metacrawler (either in front of existing search engines e.g. Google™, Yahoo™, MSN™, or as a subsystem which is more tightly integrated into an overall search engine system). The metacrawler receives the keyword and selects one or more search engines to search the content. These conventional search engines return titles, URLs and other data. The metacrawler receives these results then prepares content summaries by using each URL to request the corresponding content, then extracts the summary from that content. The resulting content summaries are arranged in a package as before, for sending to the mobile device. An additional level of summarisation of the original content items (whether they be Web pages, WAP pages, news items, sound or video clips, or local information such as e.g. yellow pages or white pages) can be created in addition to the normal annotated results list provided by search engines like Google. It transmits these content item Summaries to the mobile device as a single-shot package (a CSP) in response to a keyword-initiated search.

In embodiments where CSPs are employed these can be implemented as XHTML Mobile Profile or XHTML Basic web pages, using either bookmarks or multipart messages, allowing the result set to be arranged as a stack of linked screenviews.

The summary package includes one or more time-shared adverts and/or advert pages and/or advert sites each comprising multiple advert pages. These are retrieved from advert database 120.

The content in database 120 may be obtained directly from an advertiser. However Where an advertiser does not have mobile-specific web pages or a web site formatted for mobile devices that can be linked to from a sponsored link they can, instead, provide advertising “collateral” to the search server 50 via account management server 140. The system will then format the collateral and host it, for example using advert database 120, on behalf of the advertiser.

The advertiser can supply collateral (images, text, prices, links etc) in several ways, but one preferred method is via a desktop webpage offering a choice of templates. In this method the advertiser uses a desktop to access the search service and fill in a web form with the specifics of the advert. This can include supplying images, text, links and other advertising collateral.

The search server 50 can then link these hosted pages (Advert Pages) from the sponsored links (Advert Links) in search results. Further, these pages can even be incorporated into Content Summary Packages (the larger multi-section pages previously described above, comprised of multiple search result summaries). In this case, the sponsored link may be a bookmark link that can jump straight down the page to the Advert Pages that is included within the Content Summary Package, and not need to use the network for another fetch-response cycle (which would be several seconds delay to the user).

This concept can be further extended to hosted collections of pages, or Advert Sites. Clicking on a link on the first Advert Pages would send a URL request to the Advert Sites, which would be hosted by the search service. Advert Sites can optionally also be packaged within CSPs, so that navigation between the pages in the Advert Sites was much faster.

In addition to static, display orientated content, these hosted advert pages can also offer revenue opportunities, such as:

links that initiate phone calls (whether to zero-rated, normal or premium rated lines) links that send preformatted SMS messages (where supported by handsets), these can be used to buy ringtones, vote in TV shows, enter multiple-choice competitions and the like

links that stimulate a server to send SMSs or other message/connection types (for example to compensate for devices that do not support direct sending of SMSs). This server can be the mobile search service server or a third party server

links to URLs under the control of the users Network Operator for Network Operator service control

Hosting these pages on a server has the additional benefit of concentrating the distribution of Network Operator deals—without this centralization, advertisers would have to each make their own commercial arrangement for the hosting of content on a mobile site with an Operator.

A typical example procedure can be summarized as follows:
Spider the Web.
Extract content summaries from each web page based on a category of content found on that page (e.g. text, image, video)
Store and index summaries in an indexed database.
Receive a query, obtain search results from the indexed database.
Customize the display of the content summaries to the mobile device and/or its browser,
Send a set of summaries to user as a package, optionally include advertising material and other information of potential interest.
Display on the mobile device a short overview of items in the results, optionally including an entry to the advertising material.
Subsequently display each larger summary in response to input such as clicking on a URL, on a button, or scrolling by the user.

The search result set, plus the additional set of larger summaries of these same items, here called Content Summaries, and the adverts/links, is received by the user in a single query and response operation over the wireless network, so that the user may more easily identify the item he or she is seeking before having to initiate subsequent query and response operations over the network. Example types of content summary include (but are not restricted to) the following:
Web page text—where the content summary would be a contiguous stretch of the important, information-bearing text from a web page, with all graphics and navigation elements removed.
News stories, including web pages and news feeds such as RSS—where the content summary would be a text abstract from the original news item, plus a title, date and news source.
Images—where the content summary would be a small thumbnail representation of the original image, plus metadata such as the file name, creation date and web site where the image was found.
Ringtones—where the content summary would be a starting fragment of the ringtone audio file, plus metadata such as the name of the ringtone, format type, price, creation date and vendor site where the ringtone was found.
Video Clips—where the content summary would be a small collection (e.g. 4) of static images extracted from the video file, arranged as an animated sequence, plus metadata
Sponsored links, typically as the header or footer of each of the screenviews contained within the CSP. These are configured so that when, for example, the user clicks between screenviews, the display moves up and down to reveal the different sponsored links.

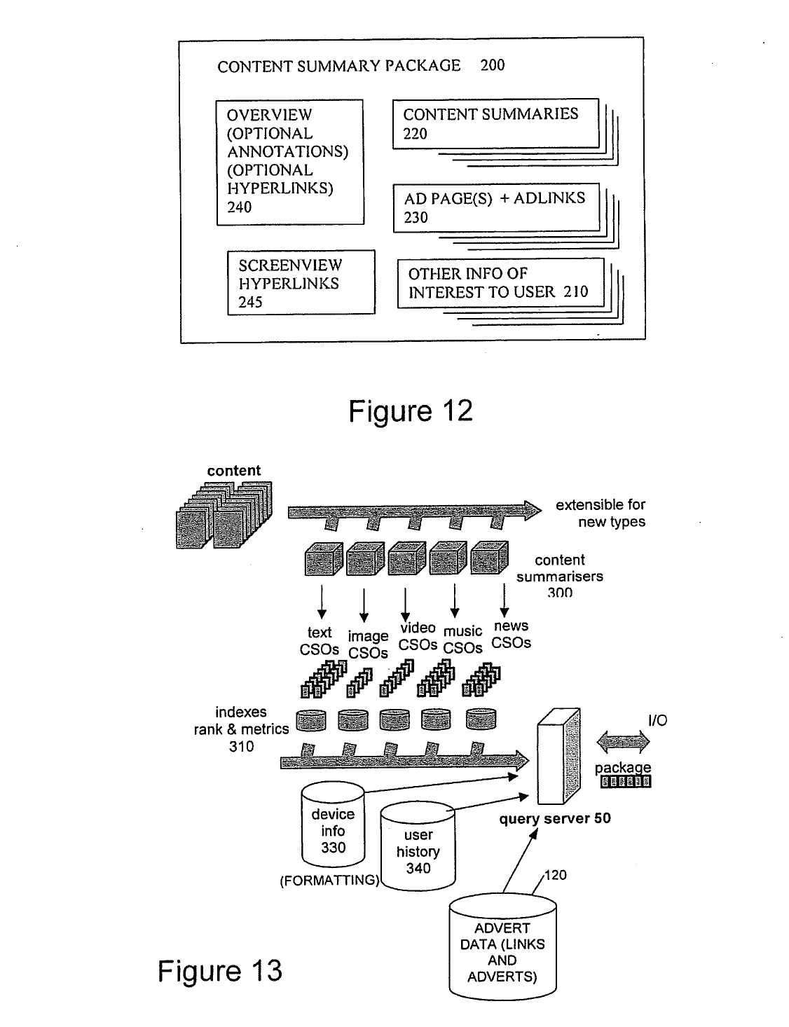

FIG. 12 shows schematically an example of a content summary package. It has an overview 240, content summaries 220, screenview hyperlinks 245, advertising screenviews including one or more sponsored links 230, and other materials 210. The overview can have optional annotations, can be formed of several screenviews showing different overviews, and optionally it can have hyperlinks to other screenviews. In some cases, the overview can be displayed in a separate frame so that it can still be viewed when viewing other screenviews.

FIG. 13 shows an example of an arrangement for creating the content summaries. Content is fed to content summarisers 300 for summarizing a different category or type of content. So one content summariser produces text content summaries, another produces image content summaries, another produces video content summaries, another produces music content summaries, another produces news content summaries. These content summaries are stored as content summary objects (CSOs) and stored in databases which are indexed. The indexes 310 are consulted when the query server 50 searches for relevant content summaries. The content summaries found are fed to the query server for incorporating into a package. A store 330 of device information and a store 340 of user history 340 are provided to enable the query server to tailor the package. As previously described the advert database 140 is also coupled to query server 50. The query server can create the overview screenviews including the advert links and/or pages and/or sites by means of content summaries, although it is not essential to use content summaries for advert links, in particular sponsored time-shared links.

The content summary database or index to it can store meta-data about its respective content item or the web page holding that item as follows. Such meta data might constitute one, some or all of the following aspects of a media item:
size
image/frame dimensions
length in time
CRC (cyclic redundancy check) over part or all of data
Embedded meta data, eg: header fields of images, videos etc
Media type, or MIME-type

The overview can be a conventional annotated list having brief descriptive information of up to 60 or so words on each item, plus other descriptive information such as the source web site, date, etc, or can be provided in other forms such as a non-annotated list, a list of groups of items, a multilevel list, capable of showing more or less information about each item or groups of items, or an array of thumbnail images, or a scrolling sequence of views of successive items, for example. One or more sponsored links is also displayed according to time period (sponsored link timesharing), for example in the header and/or footer section of the page or screenview, leaving space in the middle of the page for the search result list. In mobile devices with a landscape (instead of portrait) display form factor the left or right hand margin of the screen area may instead be employed.

Result sets from searches initiated by a mobile user can be arranged as a stack of linked content summaries, each result corresponding to a single content item. These Summaries are then combined into a single package (CSP) prior to transmission to the mobile device.

This CSP can be formatted as a webpage. Individual content summaries can be linked within Summary Packages using intra-page hyperlinks (called bookmarks in HTML, XHTML Basic and XHTML Mobile Profile). Clicking on a bookmarked link is then just a jump in the view of the current page and does not involve the browser returning to the network to fetch the next page. The user receives this Summary Package (actually a stack of web screenviews) in a single network fetch-response cycle and can then browse through the contained results with quick clicks on the intra-page links.

In XHTML Mobile Profile the anchor tag <a> with the href attribute set to a bookmark can be used to implement this method. The effect of this navigation method is to enable page-by-page scrolling rather than the pixel-by-pixel or line-by-line scrolling normally offered via the device's up/down/left/right navigation keys.

Bookmarks are a standard and well understood technique in desktop web pages. They are normally used to offer fast links to specific sections of a large documents. However, bookmarks have not often been used to link consecutive screenfuls of content—this being especially useful on a mobile device which typically has a reduced keyboard with no page up or page down key, as well as a small format display.

Content Summaries are a very convenient unit for each screenview in a linked stack of search results. Each screenview is then a candidate result item for the search query, and the set of results can be stepped through with a quick-to-load (because it's just a move) click per result. This clicking can step through results of different types (for example different media categories such as text or images) simply by arranging for the stack of content summaries (screenviews) to come from these different categories.

CSPs can incorporate sponsored links similar to those used in the desktop search service environment. Where the advertiser has mobile-specific webpages, these sponsored links can point directly at these pages. However, where an advertiser does not have mobile-specific web pages, they can instead provide advertising collateral to the search service. For each content summary item, a hyperlink having a URL can be provided to let the user click down to the underlying content item found on the WWW. Each and every page in this system can have a single Ad-link. When a user clicks on an Ad-link, an Ad-page is presented, which is a textual page which is carried in the payload of the search query response page. A link at the bottom of the Ad-page is provided to make a request over the wireless network to load further advertising material.

Screenviews

In general it is preferred (although not essential) that search results and accompanying sponsored adverts are displayed using screenviews. Examples of screenviews are described below.

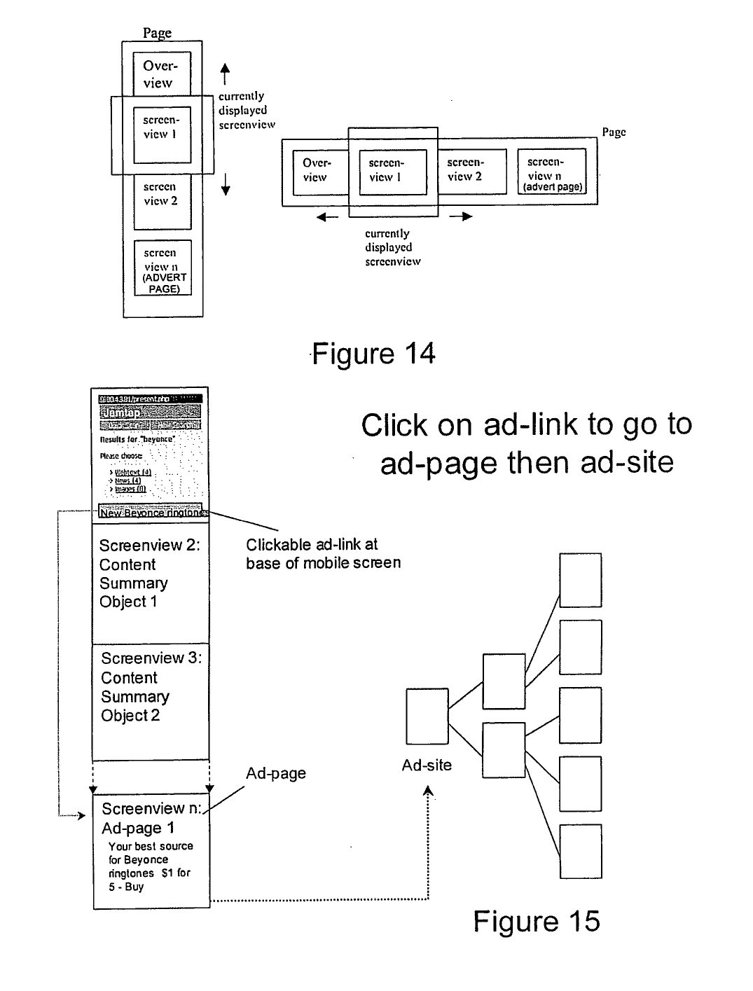

Referring to FIG. 14, an example screenview package comprises data for a page of content that can be an instance of an XHTML (or other) document that (typically) is much larger than the physical display of the mobile device, such that the width of the viewable content in this page is the same as the physical display width, but the height is much greater. This can be seen as consisting of a vertical stack of adjacent (or, optionally, spaced out with white space) screenviews such that each page region fits the display. There is also the case where the screenview may be somewhat taller than the actual display size, but still much smaller than the full content page, and the content within the bottom portion of the screenview is viewed by scrolling a little within the screenview.

As previously described, preferably a sub-section (or sections) of the mobile search result screenview (or web page) is allocated for mobile advertising purposes. In a portrait format view this may be a header or footer; in a landscape format display, a left or right margin.

Additionally or alternatively there is also a horizontal stacking case, where the page of content is defined as an instance of an XHTML or other document that was much larger than the physical display of the mobile device, such that the height of the viewable content in the page was the same as the physical display height, but the width was much greater. A page then consists of a horizontal stack of adjacent (or, optionally, spaced out with white space) screenviews such that each screenview substantially fits the display. A page may have a combination of vertically and horizontally stacked screenviews. Another possibility is a stack in the time domain, much like a timed presentation of slides or video frames, and this again can be combined with horizontal or vertical stacks. Any of these can be combined with multimedia types of presentation.

A page is one possible presentation format of a content summary Package, useful to take advantage of widespread use of browser software to read hypertext pages in mark up languages, such as the standard XHTML microbrowser built into many mobile device. If this is the chosen presentation format, then the screenview is the presentation format of an individual Content Summary.

Other presentation formats are possible, using for example a custom Java application client downloaded onto the device. In this case, a content summary Package can be formed within an XML document or even within a binary file format, and individual content summaries could be expressed likewise as (smaller) XML documents or binary files.

Screenviews are intended to encompass a portion of a web page (or other page based display medium) suitable for display by a browser or equivalent software on a mobile device. The size of a screenview can be determined dynamically by discovering the actual size of the display of the device being used, or by taking a default value based on estimates or typical devices used most frequently. A margin can be provided around the screenview to allow for different actual display sizes. The content summary sizes can be chosen to substantially fill a screenview of the mobile device. A next screenview can be selected by a user for display by scrolling, or more conveniently in some embodiments by using a hyperlink. Hyperlinks are intended to encompass hypertext, buttons, softkeys or menus or navigation bars or any displayed indication or audible prompt which can be selected by a user to cause the screenview to move to a different part of the page. Users can access a start point of the information by clicking on a button or a hypertext link embedded elsewhere in the web page. This is often much more convenient than scrolling, which is too time consuming if there are multiple screenviews to scroll through, or if it is desired to flick backwards and forwards between an overview and content summaries for example.

A package of screenviews can be implemented as a page in XHTML Basic for example. As indicated by the W3C website, XHTML Basic is the second Recommendation in a series of XHTML specifications. The XHTML Basic document type includes the minimal set of modules required to be an XHTML Host Language document type, and in addition it includes images, forms, basic tables, and object support. It is designed for Web clients that do not support the full set of XHTML features; for example, Web clients such as mobile phones, PDAs, pagers, and set top boxes. The document type is rich enough for content authoring. XHTML Basic is designed as a common base that may be extended by additional modules from XHTML Modularization such as the Scripting Module. Thus it provides a common language supported by various kinds of user agents such as browsers. It is useful if the page format can be read and presented by many different versions of “legacy” browsers to maximize the user base among existing mobile telephone users for example.

Referring now to FIG. 15 this shows an example of a clickable advert link at the bottom of the first page of a mobile device screen (preferably a screenview). Clicking on this link jumps to screen (or screenview) n, which comprises an advert page, and clicking on this in turn links to an advert site, which may be stored, for example in advert database 120 and server by server 50.

The wireless device in the above described systems may be a mobile handset type of device, or any type of mobile computing device, such as a laptop PC with a built-in connection to a wireless network, or with a connection to an external wireless device such as a mobile handset. It may be any mobile communication device adapted to operate within and receive data over a wireless communication network. It may also have voice communication capabilities. It can be any of a data messaging device, a two-way pager, a cellular telephone with data messaging capabilities, a wireless Internet appliance or a data communication device (with or without telephony capabilities), such as a laptop computer or a PDA for example. For use with a cellular network, the device may incorporate a General Packet Radio Service (GPRS) communication subsystem or other equivalent, or may use a voice telephone channel to pass the data in the form of tones for example, following established principles. The mobile device can be made up of several devices, for example it can have a separate display, separate headset or earpiece, separate keyboard, separate storage device, separate power supply and so on, each coupled by wires or wireless connections such as Bluetooth connections. The web browser on the mobile device can be suitable for presenting documents in mark up languages such as HTML and its variants, and should be HTTP compatible. Examples include Netscape Navigator, Sun Hot Java Browser, Microsoft Internet Explorer or micro browser software having similar functions. Many currently available handheld devices with browsers are at least compatible with XHTML Basic and XHTML mobile profile.

The mobile or wireless network can be a cellular network such as a GSM or UMTS or CDMA network for example. Other types of mobile devices and networks are also contemplated.

The Web server can be a PC type computer or other conventional type capable of running any HTTP (Hyper-Text-Transfer-Protocol) compatible server software as is widely available. The Web server has a connection to the Internet 30. These systems can be implemented on a wide variety of hardware and software platforms.

The query server, and servers for indexing and for searching and for metacrawling can be implemented using standard hardware. The hardware components of any server typically include: a central processing unit (CPU), an Input/Output (I/O) Controller, a system power and clock source; display driver; RAM; ROM; and a hard disk drive. A network interface provides connection to a computer network such as Ethernet, TCP/IP or other popular protocol network interfaces. The functionality may be embodied in software residing in computer-readable media (such as the hard drive, RAM, or ROM). A typical software hierarchy for the system can include a BIOS (Basic Input Output System) which is a set of low level computer hardware instructions, usually stored in ROM, for communications between an operating system, device driver(s) and hardware. Device drivers are hardware specific code used to communicate between the operating system and hardware peripherals. Applications are software applications written typically in C/C++, Java, assembler or equivalent which implement the desired functionality, running on top of and thus dependent on the operating system for interaction with other software code and hardware. The operating system loads after BIOS initializes, and controls and runs the hardware. Examples of operating systems include Linux™, Solaris™, Unix™, OSX™ Windows XP™ and equivalents.

No doubt many other effective alternatives will occur to the skilled person. For example, although preferred embodiments of the system have been mainly discussed with reference to presenting search results together with sponsored (advertising) links on a mobile device, the skilled person will recognise that the techniques described herein are not limited in their application to mobile devices as described above, but can also, for example, be employed for presenting sponsored links together with search results on a computer or other terminal such as a wired or wireless networked personal desktop or laptop computer, a wired or wireless home multimedia entertainment device, and the like. For example, preferred embodiments of the system include a web front end for desktop devices, so that people who prefer the ‘search user experience’ of the system are able to have this across all their devices, not just their mobiles.

It will be understood that the invention is not limited to the described embodiments and encompasses modifications apparent to those skilled in the art lying within the spirit and scope of the claims appended hereto.

Further aspects of the invention are defined in the following clauses:

1. A method of responding to a search query from a wireless communications device, the method comprising:

determining a collection of search results in response to the search query;
determining at least one sponsored link to be included with said collection of search results;
packaging said collection of search results with said at least one sponsored link into a data package for display on said wireless communications device; and
sending said package to said wireless communications device for display of at least one of said search results together with said at least one sponsored link.
   2. A method as defined in clause 1 wherein said determining of said at least one sponsored link comprises selecting said sponsored link from a data store comprising a plurality of sponsored links, responsive to a time of day.
   3. A method as defined in clause 2 wherein said sponsored links stored in said data store are indexed by a sequence of time of day slots each defining a time of day interval, and wherein each said sponsored link has a value associated with the time of day slot indexing to the sponsored link.
   4. A method as defined in clause 1, 2 or 3 further comprising:
receiving from said wireless communications device type identifier data identifying a type of said wireless communications device; and wherein
said packaging is responsive to said type identifier data such that said data package comprises data formatted for display on said identified type of wireless communications device.
   5. A method as defined in any preceding clause wherein said packaging comprises:
defining a plurality of screenviews for displaying said collection of search results, each said screenview comprising a substantially complete screen of display data for said wireless communications device; and
defining data of said data package such that, when displayed by said wireless communications device, said one or more sponsored links are arranged for display one per screenview.
   6. A method as defined in clause 5 wherein said packaging further comprises defining data of said data package such that a said screenview includes at least one hyperlink for intra-package navigating to another of said screenviews of said package.
   7. A method as defined in clause 5 or 6 wherein said packaging of said collection of search results comprises incorporating in said package content summaries of said search results each for display in a said screenview.
   8. A method as defined in any preceding clause wherein said packaging further comprises including advertising material comprising one or more of text data, image data and link data in said data package for display on said wireless communications device such that said at least one sponsored link navigates to said advertising material without requiring a further query-response operation across a wireless network connecting said wireless communications device.
   9. A method as defined in clause 8 when dependent upon clause 1, wherein said packaging comprises defining data of said data package such that said advertising material defines a said screenview.
   10. A method as defined in clause 9 wherein said packaging comprises defining data of said data packaging a plurality of said advertising screenviews including one or more hyperlinks for intra-package navigating between said advertising screenviews.
   11. A method as defined in clause 8, 9 or 10 wherein said advertising material link data comprises one or more of data configured to send a message having a predetermined content to a recipient, and data configured to stimulate a server to send a message to a recipient.
   12. A method as defined in any preceding clause wherein said package comprises a markup language document.
   13. A method as defined in any preceding clause wherein said package comprises application data for implementation by a client application on said wireless communications device.
   14. A method as defined in any preceding clause implemented on a search server system, and wherein said at least one sponsored link comprises a hyperlink to said search server system.
   15. A method as defined in clause 14 when dependent upon clause 8 further comprising providing a user interface including one or more templates for inputting and storing said advertising material for use by said search server system.
   16. A carrier carrying processor control code to implement the method of any preceding clause.
   17. A search server system including the code carrier of clause 16.
   18. A computer system for responding to a search query from a wireless communications device, the system comprising:
a search system interface for sending said search query to a search system and for receiving a collection of search results in response to the search query;
an advert storage system interface for receiving advertising data comprising at least one sponsored link to be included with said collection of search results;
a wireless network interface for receiving and responding to said search query from said wireless communications device;
data memory for storing data for packaging;
program memory storing processor control code; and
a processor coupled to said search system interface, said advert storage system interface, said wireless network interface, said data memory and said program memory, to load and implement said control code, said code comprising code for controlling the processor to:
obtain a collection of search results in response to the search query;
obtain at least one sponsored link to be included with said collection of search results;
package said collection of search results with said at least one sponsored link into a data package for display on said wireless communications device; and
send said package to said wireless communications device for display of at least one of said search results together with said at least one sponsored link.
   19. A computer system as defined in clause 18 wherein said code to obtain said at least one sponsored link comprises code to selectively retrieve said link via said advert storage system interface responsive to a time of day.
   20. A computer system as defined in clause 18 or 19 wherein said packaging code comprises code to define a plurality of screenviews for displaying said collection of search results, each said screenview comprising a substantially complete screen of display data for said wireless communications device; and code to define data of said data package such that, when displayed by said wireless communications device, said at least one sponsored links are arranged for display one per screenview.
   21. A computer system as defined in clause 18, 19 or 20 wherein said packaging code comprises code to include advertising material comprising one or more of text data, image data and link data in said data package for display on said wireless communications device such that said at least one sponsored link navigates to said advertising material without requiring a further query-response operation across a wireless network connecting said wireless communications device.
   22. A carrier carrying a data package responding to a search query from a wireless communications device, said data package comprising a collection of search results in response to the search query and at least one sponsored link to be included with said collection of search results.
   23. A carrier as defined in clause 22 wherein said data package comprises data defining a plurality of screenviews for displaying said collection of search results, each said screenview comprising a substantially complete screen of display data for said wireless communications device such that, when displayed by said wireless communications device, said one or more sponsored links are arranged for display one per screenview.
   24. A carrier as defined in clause 22 or 23 including advertising material comprising one or more of text data, image data and link data, in said data package for display on said wireless communications device, such that said at least one sponsored link navigates to said advertising material without requiring a further query-response operation across a wireless network connecting said wireless communications device.
   25. A method of searching over a wireless network, the method comprising sending a search query to a server and receiving in response at a mobile device a signal carrier carrying a data package as defined in clause 23, 24 or 27.
   26. A method of searching over a wireless network as defined in clause 25 when dependent upon clause 23, further comprising displaying a part of said package on said mobile device as a screenview, said screenview comprising at least one said search result in conjunction with said at least one sponsored link.
   27. A method of searching over a wireless network as defined in clause 26 when dependent upon clause 24, further comprising using said at least one sponsored link to navigate to a different screenview of said package without requiring one or more further query-response operations across said wireless network.
   28. A carrier carrying processor control code to implement the method of clause 25, 26 or 27.
   29. A mobile device including the carrier of clause 28.
   30. A system including the mobile device of clause 29, and the computer or server system of any one of clauses 17 to 21.
   31. A method of providing content formatted for a wireless communications device, the method comprising:
providing a user interface comprising at least one template for content data entry;
inputting said content data from a user using said template;
formatting said content data for said wireless communications device; and
hosting said formatted content data on a server on behalf of said user.
   32. A method as defined in clause 31 wherein said hosting further comprises adapting said content data for presentation on said wireless communications device in response to type identification data received from said wireless communications device.
   33. A method as defined in clause 31 or 32 wherein formatted content data comprises markup language data.
   34. A method as defined in clause 31 or 32 wherein formatted content data comprises application data for implementation by a client application on said wireless communications device.
   35. A method as defined in any one of clauses 31 to 34 wherein said formatted content data includes a link for initiating an outgoing phone call from said wireless communications device.
   36. A method as defined in any one of clauses 31 to 35 wherein said formatted content data includes one or more of data configured to send a message having a predetermined content to a recipient, and data configured to stimulate a server to send a message to a recipient.
   37. A method as defined in any one of clauses 31 to 36 wherein said formatted content data includes a link for accessing a service provided by an operator of a network connection said wireless communications device.
   38. A method as defined in any one of clauses 31 to 37 wherein said server comprises a server for a search service and wherein said content data comprises advertising material.
   39. A carrier carrying processor control code to implement the method of any one of clauses 31 to 38.
   40. A server comprising the carrier of clause 39.
   41. A method of displaying a plurality of sponsored links together with a plurality of search results on a mobile device, the method comprising:
displaying said search results in a plurality of screenviews each corresponding to substantially a full display screen of said mobile device; and
displaying one of said sponsored links on each said screenview.
   42. A method as defined in clause 41 further comprising providing data for said screenviews to said mobile device as a package including advertising content, said advertising content comprising a said screenview, at least one of said sponsored links linking to said advertising content comprising said screenview.

I claim:

1. A method of managing sponsored links to be transmitted to the screens of mobile devices in response to search requests from a searcher using a mobile device to access a search engine, online marketplace, or other similar service, the display of these links being responsive to time of day, the method comprising:
maintaining records of advertiser accounts for payment for responses to a said sponsored link an advertiser account comprising at least an advertiser identifier and an account balance for each of a plurality of advertisers, sponsored links that correspond to search request keywords, modifiable offer amounts submitted by said advertisers each said offer amount being associated with at least one search keyword, and records of search requests using said at least one keyword and responses to sponsored links included with search results provided in response to said search requests;
monitoring an audience for the service, said audience comprising the number of users carrying out searches within a given time interval at a said time of day;
receiving from an advertiser a request for display of a sponsored link in association with at least one said search request keyword and an offer amount, said offer amount comprising an offer of payment for responses to said sponsored link, said offer of payment applying over a time period;
forecasting a response rate for a sponsored link associated with said at least one keyword using said records of search requests using said at least one keyword and responses to sponsored links included with search results provided in response to said search requests;
adapting said forecast response rate dependent upon a total demand for sponsored links associated with said at least one keyword as determined from said request received from said advertiser and one or more said requests from one or more other said advertisers;
responding to said advertiser request using said adapted forecast response rate;
determining an adapted forecast response rate for each of said one or more other advertisers;
providing said adapted forecast response rates to said one or more other advertisers;
establishing a balance of total demand for responses to a said sponsored link associated with said at least one keyword and predicted supply of said responses, said predicted supply being determined from said forecast response rate; and
allocating said sponsored links for serving to said mobile devices with search results provided in response to search requests using said at least one keyword such that one or more sponsored links from a said advertiser offering a highest payment per response are served at least during one or more times having a highest audience.

2. A method as claimed in claim 1 wherein said allocating comprises allocating serving of said sponsored links at a given time of day such that said served sponsored links comprises links of a plurality of said advertisers, giving priority to links of said advertisers in accordance with relative magnitudes of said offers.

3. A method as claimed in claim 1 wherein said establishing a balance of total demand with predicted supply comprises repeatedly receiving modified offer amounts from one or more of said advertisers and providing adapted forecast rates to each of said advertisers requesting display of a said sponsored link in association with said at least one keyword.

4. A method as claimed in claim 1 wherein forecasting of said forecast response rate for a sponsored link associated with said at least one keyword is determined using records defining a history of responses to sponsored links included with search results provided in response to said search requests for said at least one keyword.

5. A method as claimed in claim 1 further comprising determining a set of said timeslots for said sponsored link display for said at least one search request keyword, said timeslots being determined to discriminate between peak and off-peak periods of said audience; and wherein said responding to said advertiser request further comprises providing a time quality indicator dependent upon said adapted forecast response rate for said determined timeslots.

6. A method as claimed in claim 5 wherein determining of said set of timeslots is responsive to records defining a history of responses to sponsored links included with search results provided in response to said search requests for said at least one keyword.

7. A method as claimed in claim 1 wherein a said offer amount received from said advertiser further comprises a budget value defining an upper limit of payment be said advertiser over said time period; and wherein said allocating is responsive to said budget value to limit said sponsored links served in association with said at least one keyword for an advertiser during said time period.

8. A method as claimed in claim 7 further comprising determining link allocation data, said link allocation data defining a division of said sponsored links between said advertisers, said division of sponsored links determining for a search request for said at least one keyword, which advertisers sponsored link or links is to be included with the search results provided in response to the request, said determination of link allocation data being responsive to said budget value and said forecast response rate.

9. A method as claimed in claim 7, wherein said allocating of said sponsored links is performed in substantially real time response to a search query including said at least one keyword from a mobile device.

10. A method as claimed in claim 9 wherein said allocating comprises maintaining a record of a number of responses served for each said advertiser having a said sponsored link associated with said at least one keyword during a said time period, determining a link to serve with search results provided in response to said query using said record of responses, and updating said record in response to said provision of said search results.

11. A method as claimed in claim 1 further comprising:
determining a relevant set of search results in response to reception of at least one said search query keyword from a said mobile device;
determining a set of sponsored links from competing advertisers to be displayed adjacent to or included within the search result list on a screen of the said mobile device; and
packaging said collection of search results and at least one sponsored link from said set into a data package for display on the screen of the mobile device.

12. A carrier carrying processor control code to, when running, implement the method of claim 1.

13. A method of managing sponsored links to be transmitted to the screens of mobile devices in response to search requests from a searcher using a mobile device to access a search engine, online marketplace, or other similar service, the display of these links being matched to geographical location, the method comprising:
maintaining records of advertiser accounts for payment for responses to a said sponsored link an advertiser account comprising at least an advertiser identifier and an account balance for each of a plurality of advertisers, sponsored links that correspond to search request keywords, modifiable offer amounts submitted by said advertisers each said offer amount being associated with at least one search keyword, and records of search requests using said at least one keyword and responses to sponsored links included with search results provided in response to said search requests;
monitoring an audience for the service, said audience comprising the number of users carrying out searches within a given time interval at a said geographical location;
receiving from an advertiser a request for display of a sponsored link in association with at least one said search request keyword and an offer amount, said offer amount comprising an offer of payment for responses to said sponsored link, said offer of payment applying over a time period;
forecasting a response rate for a sponsored link associated with said at least one keyword using said records of search requests using said at least one keyword and responses to sponsored links included with search results provided in response to said search requests;
adapting said forecast response rate dependent upon a total demand for sponsored links associated with said at least one keyword as determined from said request received from said advertiser and one or more said requests from one or more other said advertisers;
responding to said advertiser request using said adapted forecast response rate;
determining an adapted forecast response rate for each of said one or more other advertisers;
providing said adapted forecast response rates to said one or more other advertisers;
establishing a balance of total demand for responses to a said sponsored link associated with said at least one keyword and predicted supply of said responses, said predicted supply being determined from said forecast response rate; and
allocating said sponsored links for serving to said mobile devices with search results provided in response to search requests using said at least one keyword such that one or more sponsored links from a said advertiser offering a highest payment per response are served at least for one or more geographical locations having a highest audience.

14. A carrier carrying processor control code to, when running, implement the method of claim 13.

15. A system for managing sponsored links to be transmitted to the screens of mobile devices in response to search requests from a searcher using a mobile device to access a search engine, online marketplace, or other similar service, the display of these links being responsive to time of day, the system comprising:
at least one records system for maintaining records of advertiser accounts for payment for responses to a said sponsored link an advertiser account comprising at least an advertiser identifier and an account balance for each of a plurality of advertisers, sponsored links that correspond to search request keywords, modifiable offer amounts submitted by said advertisers each said offer amount being associated with at least one search keyword, and records of search requests using said at least one keyword and responses to sponsored links included with search results provided in response to said search requests;
an audience monitoring system for monitoring an audience for the service, said audience comprising the number of users carrying out searches within a given time interval at a said time of day;
an interface for receiving from an advertiser a request for display of a sponsored link in association with at least one said search request keyword and an offer amount, said offer amount, said offer amount comprising an offer of payment for responses to said sponsored link, said offer of payment applying over a time period; and
a processor coupled to data memory and to program memory storing processor control code, the code comprising code for controlling the processor to:
forecast a response rate for a sponsored link associated with said at least one keyword using said records of search requests using said at least one keyword and responses to sponsored links included with search results provided in response to said search requests;
adapt said forecast response rate dependent upon a total demand for sponsored links associated with said at least one keyword as determined from said request received from said advertiser and one or more said requests from one or more other said advertisers;
respond to said advertiser request using said adapted forecast response rate;
determine an adapted forecast response rate for each of said one or more other advertisers;
provide said adapted forecast response rates to said one or more other advertisers;
establish a balance of total demand for responses to a said sponsored link associated with said at least one keyword and predicted supply of said responses, said predicted supply being determined from said forecast response rate; and
allocate said sponsored links for serving to said mobile devices with search results provided in response to search requests using said at least one keyword such that one or more sponsored links from a said advertiser offering a highest payment per response are served at least during one or more geographical locations having a highest audience.

16. A system for managing sponsored links to be transmitted to the screens of mobile devices in response to search requests from a searcher using a mobile device to access a search engine, online marketplace, or other similar service, the display of these links being matched to geographical location, the system comprising:
at least one records system for maintaining records of advertiser accounts for payment for responses to a said sponsored link an advertiser account comprising at least an advertiser identifier and an account balance for each of a plurality of advertisers, sponsored links that correspond to search request keywords, modifiable offer amounts submitted by said advertisers, each said offer amount being associated with at least one search keyword, and records of search requests using said at least one keyword and responses to sponsored links included with search results provided in response to said search requests;
an audience monitoring system for monitoring an audience for the service, said audience comprising the number of users carrying out searches within a given time interval at a said geographical location;
an interface for receiving from an advertiser a request for display of a sponsored link in association with at least one said search request keyword and an offer amount, said offer amount, said offer amount comprising an offer of payment for responses to said sponsored link, said offer of payment applying over a time period; and
a processor coupled to data memory and to program memory storing processor control code, the code comprising code for controlling the processor to:
forecast a response rate for a sponsored link associated with said at least one keyword using said records of search requests using said at least one keyword and responses to sponsored links included with search results provided in response to said search requests;
adapt said forecast response rate dependent upon a total demand for sponsored links associated with said at least one keyword as determined from said request received from said advertiser and one or more said requests from one or more other said advertisers;
respond to said advertiser request using said adapted forecast response rate;
determine an adapted forecast response rate for each of said one or more other advertisers;
provide said adapted forecast response rates to said one or more other advertisers;
establish a balance of total demand for responses to a said sponsored link associated with said at least one keyword and predicted supply of said responses, said predicted supply being determined from said forecast response rate; and
allocate said sponsored links for serving to said mobile devices with search results provided in response to search requests using said at least one keyword such that one or more sponsored links from a said advertiser offering a highest payment per response are served at least for one or more geographical locations having a highest audience.

17. A method of responding to a search query from a wireless communications device, the method comprising:
determining a collection of search results in response to the search query;
determining at least one sponsored link to be included with said collection of search results;
packaging said collection of search results with said at least one sponsored link into a data package for display on said wireless communications device; and
sending said package to said wireless communications device for display of at least one of said search results together with said at least one sponsored link; and
wherein said determining of said at least one sponsored link comprises selecting said sponsored link from a data store comprising a plurality of sponsored links, responsive to a time of day.

18. A method as claimed in claim 17 wherein said sponsored links stored in said data store are indexed by a sequence of time of day slots each defining a time of day interval, and wherein each said sponsored link has a monetary value associated with the time of day slot indexing to the sponsored link.

19. A method as claimed in claim 17 further comprising:
receiving from said wireless communications device type identifier data identifying a type of said wireless communications device; and wherein
said packaging is responsive to said type identifier data such that said data package comprises data formatted for display on said identified type of wireless communications device.

20. A method as claimed in claim 17 wherein said packaging comprises:
defining a plurality of screenviews for displaying said collection of search results, each said screenview comprising a substantially complete screen of display data for said wireless communications device; and
defining data of said data package such that, when displayed by said wireless communications device, said one or more sponsored links are arranged for display one per screenview.

21. A method as claimed in claim 20 wherein said packaging further comprises defining data of said data package such that a said screenview includes at least one hyperlink for intra-package navigating to another of said screenviews of said package.

22. A method as claimed in claim 20 wherein said packaging of said collection of search results comprises incorporating in said package content summaries of said search results each for display in a said screenview.

23. A method as claimed in claim 17 wherein said packaging further comprises including advertising material comprising one or more of text data, image data and link data in said data package for display on said wireless communications device such that said at least one sponsored link navigates to said advertising material without requiring a further query-response operation across a wireless network connecting said wireless communications device.

24. A carrier carrying processor control code to implement the method of claim 17.

25. A computer system for responding to a search query from a wireless communications device, the system comprising:
a search system interface for sending said search query to a search system and for receiving a collection of search results in response to the search query;
an advert storage system interface for receiving advertising data comprising at least one sponsored link to be included with said collection of search results;
a wireless network interface for receiving and responding to said search query from said wireless communications device;
data memory for storing data for packaging;
program memory storing processor control code; and
a processor coupled to said search system interface, said advert storage system interface, said wireless network interface, said data memory and said program memory, to load and implement said control code, said code comprising code for controlling the processor to:
obtain a collection of search results in response to the search query;
obtain at least one sponsored link to be included with said collection of search results;
package said collection of search results with said at least one sponsored link into a data package for display on said wireless communications device;
send said package to said wireless communications device for display of at least one of said search results together with said at least one sponsored link; and
wherein said code to obtain said at least one sponsored link comprises code to selectively retrieve said link via said advert storage system interface responsive to a time of day.

26. A computer system as claimed in claim 25 wherein said packaging code comprises code to define a plurality of screenviews for displaying said collection of search results, each said screenview comprising a substantially complete screen of display data for said wireless communications device; and code to define data of said data package such that, when displayed by said wireless communications device, said at least one sponsored links are arranged for display one per screenview.
